(19) United States
(12) Patent Application Publication
(10) Pub. No.: US 2010/0313840 A1
(43) Pub. Date: Dec. 16, 2010

(54) METHOD AND SYSTEM FOR CONVERTING WASTE INTO ENERGY

(75) Inventors: Andrew Eric Day, Longmeadow, MA (US); Eric Day, Longmeadow, MA (US)

Correspondence Address: CANTOR COLBURN LLP, 20 Church Street, 22nd Floor, Hartford, CT, 06103, US

(73) Assignee: DAYS ENERGY SYSTEMS, Longmeadow, MA (US)

(21) Appl. No.: 12/774,362

(22) Filed: May 5, 2010

Related U.S. Application Data
(60) Provisional application No. 61/175,540, filed on May 5, 2009.

(51) Int. Cl. F02B 43/08; B01J 19/00; C01B 3/38; C10L 1/182

(52) U.S. Cl. 123/1 A; 422/129; 422/198; 252/373; 44/639; 44/411

(57) ABSTRACT

Disclosed herein is a system comprising a reciprocating water gas shift reactor; the water gas shift reactor being operative at speeds down to about 1 revolution per minute, while converting carbon monoxide (CO) and steam (H₂O) into carbon dioxide (CO₂) and hydrogen (H₂). Disclosed herein too is a system comprising a hydrogen engine, or fuel cell with electric motor, and a water gas shift reactor; the hydrogen engine, or fuel cell with electric motor being in operative to drive the water gas shift reactor at speeds down to about 1 revolution per minute; and operative to convert carbon monoxide (CO) and steam (H₂O), into carbon dioxide (CO₂) and hydrogen (H₂).

### CROSS-REFERENCE TO RELATED APPLICATIONS

This application claims priority to U.S. Provisional Application No. 61/175,540 filed on May 5, 2009 the entire contents of which are hereby incorporated by reference.

### BACKGROUND

This disclosure relates to a method and a system for converting waste into energy.

Human beings generate large amounts of waste across the world everyday. In addition to the waste generated by everyday human activity, waste is also generated by industrial and manufacturing activity. Some of this waste is discharged into landfills, while other portions of this waste are discharged into the ground or into bodies of water such as streams, rivers and oceans. This waste is often hazardous to living beings. For example, runoff from landfills can get into ground water thereby contaminating it. Toxic wastes from industrial facilities can also contaminate the atmosphere as well as bodies of water such as streams, rivers and oceans. Gases discharged from industrial facilities often contain carbon dioxide, which is believed to contribute to global warming.

In addition, waste that was stored in landfills is often burnt in order to reduce its volume so that the landfill can be used for extended periods of time. However, the burning of waste matter often produces carbon dioxide. This is now considered to be environmentally hazardous because they contribute to global warming. Heavy metals, dioxins and furans, which are generally considered to be toxins are also produced.

It is therefore desirable to be able to dispose of some of the waste matter that is generated by living beings in a manner that protects the environment. It is further desirable to recycle some of this waste into energy so as to reduce the cost of energy generation as well as to recover some of the energy that is expended in the manufacturing of products that ends up as waste. It is also desirable to generate energy from waste that is discarded to landfills in a manner that does not further degrade the environment, and produces fuel for combustion engines.

It is also desirable to produce synthetic fuels for use in automobiles, factories, airplanes, and the like. One of the drawbacks of producing synthetic fuels is that the desired ratio or hydrogen to carbon is seldom easily available. It is therefore desirable to increase the amount of hydrogen so that fuels can be produced inexpensively and efficiently. It is also desirable to use waste and other carbonaceous materials as feedstock to produce large quantities of liquid and gaseous fuels, while minimizing carbonaceous emissions to the atmosphere.

### SUMMARY

Disclosed herein is a system comprising a reciprocating water gas shift reactor; the water gas shift reactor being operative at speeds down to about 1 revolution per minute, while converting carbon monoxide (CO) and steam (H₂O) into carbon dioxide (CO₂) and hydrogen (H₂).

Disclosed herein too is a system comprising a hydrogen engine, or fuel cell with electric motor, and a water gas shift reactor; the hydrogen engine, or fuel cell with electric motor being in operative to drive the water gas shift reactor at speeds down to about 1 revolution per minute; and operative to convert carbon monoxide (CO) and steam (H₂O), into carbon dioxide (CO₂) and hydrogen (H₂).

Disclosed herein too is a system comprising a split cycle reciprocating internal combustion engine, and water gas shift reactor; the internal combustion engine, and water gas shift reactor, being operative to function with alternating power, and water gas shift reaction, from the same cylinders.

Disclosed herein too is a method comprising displacing a reciprocating piston to draw carbon monoxide into a cylinder; compressing the carbon monoxide; injecting steam and/or water into the cylinder; mixing the carbon dioxide and stream to have fluid communication with a catalyst in the cylinder; converting the carbon monoxide and steam into carbon dioxide and hydrogen; and discharging carbon dioxide and hydrogen from the cylinder.

Disclosed herein too is a system comprising a reciprocating water gas shift reactor; the reciprocating water gas shift reactor being operative to function with a synthesis gas to liquid fuel plant; and the inputs and outputs of the reciprocating water gas shift reactor, being operative to synergistically match those of the syngas to liquid fuel plant.

### BRIEF DESCRIPTION OF FIGURES

FIG. 1 is an exemplary depiction of a system that comprises a high temperature gasifier in communication with an algae bioreactor and with a water gas shift reactor;

FIG. 2 shows one embodiment of a reciprocating water gas shift reactor;

FIG. 3 shows a reciprocating hydrogen engine for the conversion of hydrogen obtained from either the gasifier or the water shift reactor into water;

FIG. 4 is a depiction of the 4-stroke water shift reactor of the FIG. 2 being in operative communication with the 4-stroke hydrogen engine of the FIG. 3;

FIGS. 5 and 6 represent a 6-stroke water gas shift reaction engine and a 6-stroke hydrogen engine;

FIG. 7 depicts a 6-stroke hydrogen engine in communication with a 6-stroke water gas shift reactor;

FIG. 7 is an exemplary depiction of the system wherein the hydrogen loop comprises a heat recovery boiler instead of the hydrogen engine that is depicted in the FIG. 3. The heat recovery boiler takes heat from the hydrogen and converts water into steam;

FIG. 8 depicts a single cylinder that can serve as a 4 stroke hydrogen engine and a 4 stroke water gas shift reactor in sequence;

FIG. 9 depicts a split stroke water gas shift reactor;

FIG. 10 is a depiction of a split stroke device where two stroke upstream cylinders are in communication with a plurality of two stroke downstream cylinders;

FIGS. 11, 12 and 13 depict another variation on the two stroke water shift reactor;

FIG. 14 depicts using a four valve cylinder head (cylinders 1200 and 1400 respectively) fed by dedicated supply cylinders (item 1100 and 1300 respectively) for the internal combustion engine and the water gas shift reaction respectively;

FIGS. 15, 16 and 17 depict a 6-stroke combustion and water gas shift reactor;

FIG. 18 shows that oxygen and carbon dioxide from the algae bioreactor are compressed in the cylinder while at the same time carbon monoxide, methane, syngas or combinations thereof from the plasma gasifier are compressed in another cylinder;

FIGS. 19 and 20 show an 8-stroke engine that is used as a water gas shift reactor to convert syngas from the gasifier to form carbon dioxide and hydrogen; and

FIG. 21 depicts a 10-stroke engine that is used as a water gas shift reactor to convert syngas from the gasifier to form carbon dioxide and hydrogen.

### DETAILED DESCRIPTION

It is to be noted that as used herein, the terms “first,” “second,” and the like do not denote any order or importance, but rather are used to distinguish one element from another, and the terms “the”, “a” and “an” do not denote a limitation of quantity, but rather denote the presence of at least one of the referenced item. Furthermore, all ranges disclosed herein are inclusive of the endpoints and independently combinable.

Furthermore, in describing the arrangement of components in embodiments of the present disclosure, the terms “upstream” and “downstream” are used. These terms have their ordinary meaning. For example, an “upstream” device as used herein refers to a device producing a fluid output stream that is fed to a “downstream” device. Moreover, the “downstream” device is the device receiving the output from the “upstream” device. However, it will be apparent to those skilled in the art that a device may be both “upstream” and “downstream” of the same device in certain configurations, e.g., a system comprising a recycle loop.

While the following description details reciprocating engines, the systems may be adapted to rotary engines as well. The reciprocating engine can be substituted with the rotary engine or coupled with a rotary engine if desirable.

Disclosed herein is a method and a device for manufacturing synthetic fuels and other precursors to synthetic fuels using a reciprocating water shift reactor. In one embodiment, the device comprises a gasifier for converting waste matter into a mixture of hydrogen and carbon monoxide, a synthesis reactor that converts carbon dioxide into carbohydrate and a reciprocating water gas shift reactor for converting carbon monoxide into carbon dioxide. The device may optionally comprise a liquid fuel plant for converting carbon monoxide to produce liquid fuels. The reciprocating water shift reactor may use a plurality of strokes to convert carbon monoxide into carbon dioxide.

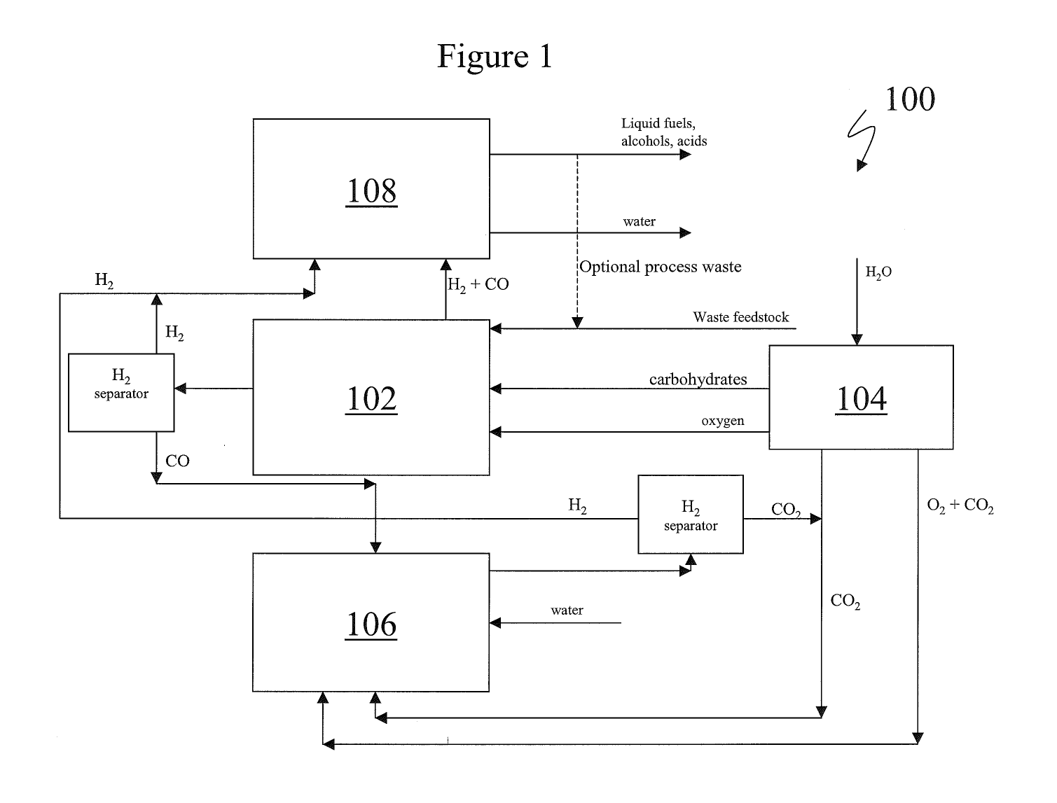

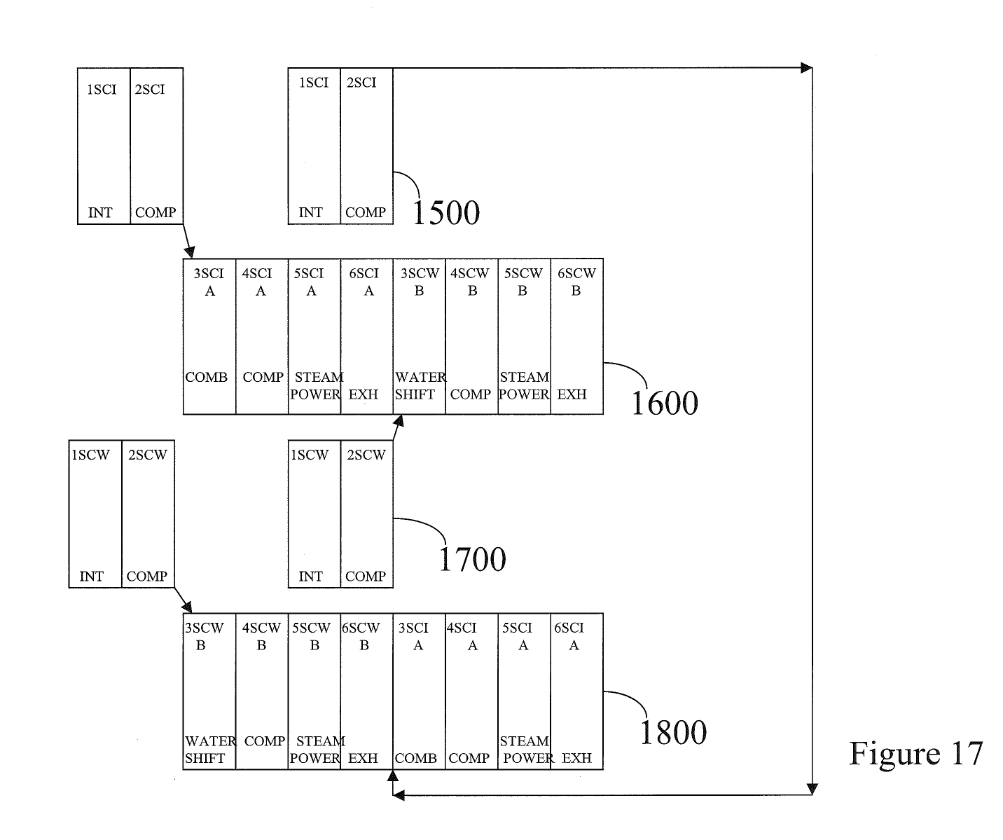

FIG. 1 is an exemplary depiction of a device 100 that can be used to convert waste matter into liquid fuel. The device 100 comprises a gasifier 102, a synthesis reactor 104, a water gas shift reactor 106 and a gas to liquid fuel plant 108. The gas to liquid fuel plant 108 will operate in conjunction with any of the FIGS. 1-20 below. These will be discussed in detail later.

The use of a reciprocating engine has numerous advantages, which are listed below. Oxygen plant parasitical loss can be completely eliminated, replaced by the bioreactor. The use of a hydrogen engine in conjunction with a water shift reactor provides synergies not hitherto realized. The steam generated from the hydrogen engine can be used in the water shift reactor. The enables capturing of the latent heat of vaporization. The hydrogen has a faster flame front than petroleum. This reduces piston down travel per given amount of energy released from fuel burned. The net result is a smaller volume per BTU released, hence greater cylinder pressure. The higher the percentage of oxygen the faster the flame front. This also enables more complete fuel burn near top dead center. The volume is reduced @ the top dead center as the nitrogen is not present as would be using atmospheric air. This also increases cylinder pressure. By utilizing the engine and syngas waste heat for the water shift reaction efficiency is increased.

In one embodiment, the gasifier 102 is a high temperature reactor. The gasifier can be used to gasify, pyrolyze and/or combust the feedstream. It is generally desirable for the gasifier 102 to operate in an oxygen-controlled atmosphere at a temperature that is effective to break down the feed stream of waste into its basic elements and compounds, such as, for example carbon monoxide and hydrogen. Examples of gasifier 102 are plasma gasifiers, oxygen injection gasifiers and Bessemer converters, or the like, or a combination comprising at least one of the foregoing gasifiers. In order to achieve this, it is generally desirable for the gasifier 102 to operate at temperatures of about 450° F. to about 40,000° F. Within this range, it is desirable for the gasifier 102 to operate at a temperature of greater than or equal to about 1,000° F., specifically greater than or equal to about 2,000° F., specifically greater than or equal to about 3,000° F., specifically greater than or equal to about 4,000° F., specifically greater than or equal to about 5,000° F., more specifically greater than or equal to about 7,500° F., specifically greater than or equal to about 10,500° F., specifically greater than or equal to about 12,500° F., specifically greater than or equal to about 14,500° F., specifically greater than or equal to about 17,500° F., specifically greater than or equal to about 20,000° F., and more specifically greater than or equal to about 25,500° F. An exemplary gasifier 102 is a plasma gasifier that can operate at temperatures of up to about 50,000° F.

Other gasifiers are generally not able to break down all materials found in municipal waste because of their lower operating temperatures when compared with plasma gasifiers and therefore permit toxins to be released into the surroundings. This however, does not preclude the use of the other types of gasifiers in conjunction with the plasma gasifiers, where desirable. Various types of gasifiers are listed below. These are

Air fed gasifiers. These can achieve temperatures up to about 2,000° C. They operate with partial air combustion.

Oxygen fed gasifiers. These can achieve temperatures up to about 3,000° C. They operate with partial oxygen combustion.

Plasma gasifiers. These can achieve temperatures above 16,000° C.

Ionized gas known as plasma is a good conductor of electricity. An electric arc struck within the plasma can produce these very high temperatures and with the elimination of fuel combustion can achieve superior environmental performance. By using water as an oxygen source, hydrogen is released when converting carbon to carbon monoxide and carbon dioxide.

i.e. C+H₂O→CO+H₂

Plasma gasifiers are generally superior to other gasifiers in that they heat up the feedstock electrically and independently of the oxygen input, while other gasifiers, which use oxygen to heat up the feedstock are limited to the amount of oxygen suitable to transpose carbon into carbon monoxide. This limits the operating temperature of the gasifier. As a result, plasma gasifiers are a good choice to break down waste (e.g., municipal and industrial waste) into their basic elements and compounds, due to the higher temperature needed to break down the wide array of unknown materials found in them.

Molten metal gasifiers. These operate with a plasma heat source or electrical induction.

Solar gasifiers. These can achieve temperatures up to about 30,000° C. Of the aforementioned gasifiers, plasma gasifiers are preferred.

During processing in the plasma gasifier, the hydrocarbons and the carbohydrates in the waste stream are converted into carbon monoxide and hydrogen. The combination of carbon monoxide and hydrogen is sometimes referred to as “syngas”. As will be described later in this text, the combination of carbon monoxide and hydrogen from the high temperature gasifier is fed to the gas to liquid fuel plant 108 for further processing. Other products resulting from the breakdown of the waste stream such as, for example, base metals, silica, and the like, can be drained off from the gasifier 102 in the form of a molten discharge and can be solidified upon cooling (not shown). These products can eventually be used for metal recovery, while other forms of low value slag obtained from the gasifier 102 can be used as building materials for industrial products. In one embodiment, the heat energy in these products can be recovered and used together with heat from other parts of the system to heat inlet water to a steam boiler or to evaporate a refrigerant gas to power a low temperature gas turbine engine or the like.

For the gasifier 102 to supply syngas (carbon monoxide and hydrogen), the supply of oxygen is to be carefully controlled. Oxygen in the form of air, steam or water in the gasifier 102 initially increases the formation of carbon monoxide, and then continues to transform this into carbon dioxide. In the case where excess moisture in the feedstock creates makes it desirable to reduce the oxygen level in the gasifier 102, this can be done by adding dry hydrocarbon (e.g., dry used tires, which adds carbon and hydrogen but not oxygen) to the feedstock. Tornado dryers and/or other moisture evaporation equipment (not shown) may also be employed to control the entry of moisture to the gasifier 102.

In one embodiment, the gas produced in the gasifier 102 comprises an amount of greater than or equal to about 25 volume percent (vol %) carbon monoxide, specifically greater than or equal to about 30 vol % carbon monoxide, specifically greater than or equal to about 40 vol % carbon monoxide, specifically greater than or equal to about 50 vol % carbon monoxide, and more specifically greater than or equal to about 65 vol % carbon monoxide, based on the total volume of gas produced at any period in time in the gasifier 102. The amount of carbon dioxide is generally less than or equal to about 8 vol %, specifically less than or equal to about 6 vol %, based on the total volume of gas produced at any period in time in the gasifier 102.

In one embodiment, it is desirable to increase the flow of feedstock through the gasifier while reducing the amount of oxygen to the gasifier 102. The solid waste products are converted to carbon, glass, metals, and the like, upon being heated in the gasifier 102. The carbon monoxide along with the hydrogen can be discharged from the gasifier 102. The carbon and carbon particulates can be filtered out of the discharge from the plasma gasifier, while the hydrogen can be harvested. The harvested hydrogen can be used to generate energy.

The synthesis reactor 104 contains algae and is in a recycle loop with the high temperature gasifier and is used to absorb carbon dioxide and nitrogen and to release oxygen as a byproduct. It is generally desirable that the amount of oxygen released be similar to the carbon dioxide absorbed. The time for the transformation for the carbon dioxide to the oxygen is brief. Algae is one of the fastest growing plants on earth and for every ton of municipal waste processed, absorbs approximately 2600 lbs of carbon dioxide and releases approximately 1250-1900 lbs of oxygen.

In one embodiment, the synthesis reactor 104 is an algae bioreactor, a photo plankton reactor, an enzyme reactor, a bacterial reactor, viral reactor, or the like, or a combination comprising at least one of the foregoing synthesis reactors. Algae bioreactors are generally superior to other synthesis reactors, and function by photosynthesizing carbon dioxide with water in the presence of sunlight. This however does not preclude the use of other synthesizers that do not use photosynthesis in conjunction with algae bioreactors where desirable.

As noted above, the synthesis reactor 104 consumes the carbon dioxide produced in the water gas shift reactor. The synthesis reactor 104 is an optically transparent device (or use directed light) that uses the carbon dioxide and sunlight to grow oil rich algae. The exposure of algae to sunlight, water and CO₂ facilitates photosynthesis. To grow the algae, CO₂ is fed into a series of transparent “bioreactors”, which are filled with green microalgae suspended in nutrient-rich water (hereinafter “soup”). The algae use the CO₂, along with sunlight and water, to produce sugars by photosynthesis, which are then metabolized into fatty acids (lipids), complex carbohydrates, oils and protein. As the algae grow and multiply, portions of the soup are withdrawn from each reactor and can be dried into cakes of concentrated algae. These can be crushed or repeatedly washed with solvents to extract the oil. The algal oil can then be converted into biodiesel through a process called transesterification, in which it is processed using ethanol and a catalyst. Enzymes can then be used to convert starches from the remaining biomass into sugars, which are fermented by yeasts to produce ethanol.

Synthesis reactors 104 use high absorption algae, which in the presence of sunlight feed on carbon dioxide to become a valuable source of oil rich carbohydrate. The carbon dioxide that would have been exhausted to the atmosphere is now converted from a global warming pollutant to a useful feedstock that is rich in hydrogen as shown in the theoretical reaction (III) below:

3.95CO₂+3.95H₂O [symbol] C_{3.95}H_{7.90}O_{2.61}+4.52O₂ (I)

where algae is half carbohydrate and half lipid oil.

In general terms the transformation may be described as shown in the reaction

(IV) below:

nCO₂+2nH₂O [symbol] (CₙH₂ₙOₙ)ₙ+nH₂O+nO₂ (II)

where n is about 3 to about 1510, ATP is adenosine triphosphate and NADPH is nicotinamide adenosine dinucleotide phosphate. It is to be noted that the formula for many carbohydrates may also be written as Cₙ(H₂O)ₙ. Examples of suitable carbohydrates are glucose, ketoses, monosaccharides, disaccharides, oligosaccharides and polysaccharides.

A water gas shift reactor converts operates at elevated temperatures of about 350° F. to about 2,200° F. and combines steam with carbon monoxide derived from the high temperature gasifier 110 to produce carbon dioxide. This is described in reaction (III) below:

2CO+H₂+2H₂O (steam) [symbol] 2CO₂+3H₂ (III)

When the gasifier 102 is a plasma gasifier, the high temperature of the gases obtained from the plasma gasifier makes the combination of the water gas shift reactor with the plasma gasifier very advantageous. At higher temperatures, the reaction depicted in the equation (III) is driven towards the right hand side of the equation. This results in greater conversions of carbon monoxide to carbon dioxide with greater production of hydrogen. If it is desirable to carry out the reaction shown in the equation (III) at a lower temperature, then catalysts that comprise transition metals or transition metal oxides can be used to catalyze the reaction. The catalysts used are iron oxide promoted with chromium oxide, copper with zinc oxide and aluminum oxide, or combinations thereof.

The hydrogen generated in the water gas shift reactor can be harvested for use in a gas to liquid fuel plant 108, fuel cell (not shown), a hydrogen boiler (not shown) or in a hydrogen engine (not shown), while the carbon dioxide can be directed to the synthesis reactor 104. As noted previously, it is desirable for the synthesizing reactor to be an algae bioreactor. In a fuel cell, the hydrogen is reacted with oxygen to produce water (steam) and electricity, the latter of which is can be used to power an electric motor, if desired.

Other devices that may be used in conjunction with the device 100 are a hydrogen engine and a syngas engine. Both of these engines are not shown in the FIG. 1.

The hydrogen engine is an internal combustion engine that ignites hydrogen with oxygen in its combustion chambers and that can be used to drive an electric generator, a motor, or other devices that convert energy from one form to another. When a boiler is used, steam from the boiler can be used to drive a steam engine or turbine, which drives an electric generator or other energy generation device. In the embodiment, the exhaust gas from the combustion in the hydrogen engine comprises steam and can be recycled to the water shift gas reactor to facilitate the reaction (III) as detailed above. In another embodiments, the exhaust gas (from the hydrogen engine or boiler) that comprises steam can be condensed to yield clean water.

A syngas engine, ignites the hydrogen and carbon monoxide gases with oxygen in the engine combustion chamber and can be used to drive and electric generator and other devices. The exhaust gases from this process is steam, carbon dioxide (and some inert gases). The carbon dioxide, which can be fed downstream towards the algae bioreactor after recovering heat energy for useful work. This is shown in the reaction (IV) below:

Syngas+Oxygen+Heat Release [symbol] Carbon dioxide+Steam (IV)

A hydrogen separator is used to separate hydrogen from carbon dioxide. In particular, it is desirable to separate hydrogen from carbon dioxide that is generated in the water shift reactor. In one embodiment, the hydrogen separator utilizes separation by gravity (hydrogen being 44 times lighter than carbon dioxide) to separate hydrogen from carbon dioxide. In another embodiment, a membrane can be used to separate hydrogen from other elements and compounds that are present in hydrogen containing mixtures obtained from the device 100. The membrane used in the hydrogen separator may be an inorganic membrane. A suitable inorganic membrane can comprise ceramics. Combinations of membrane and gravity separation can be used to separate the hydrogen from carbon dioxide.

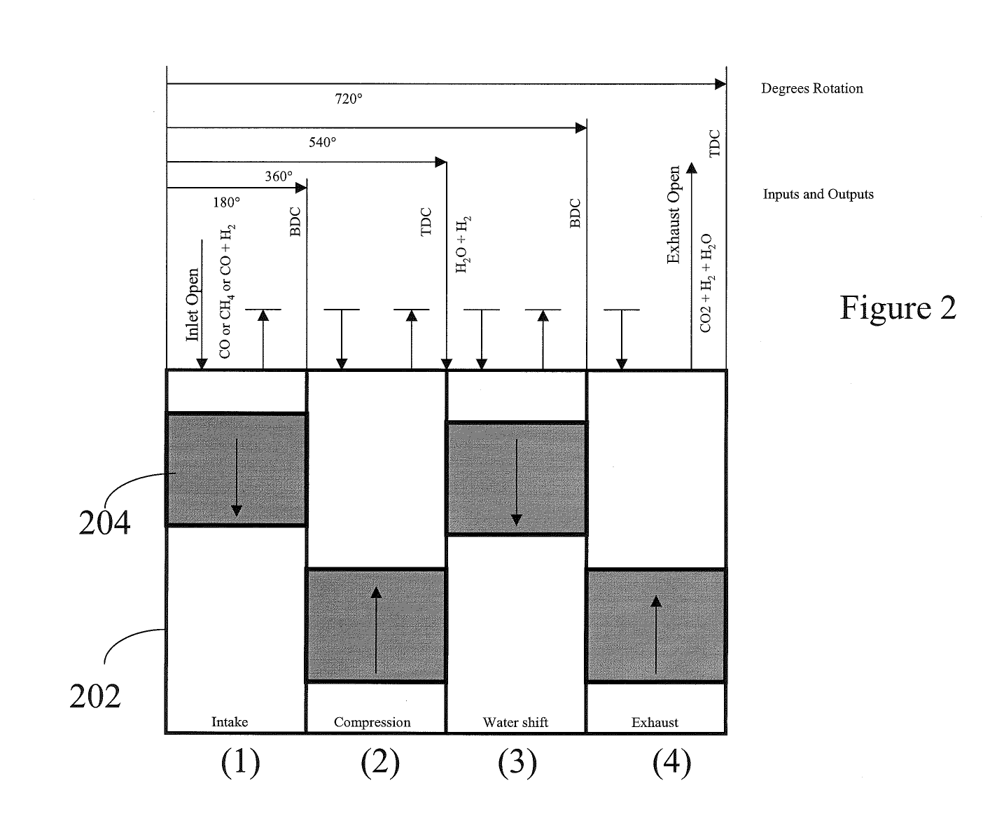

As detailed above, the water gas shift reactor 106 is a reciprocating device. The FIG. 2 shows one embodiment of a water gas shift reactor 106. The FIG. 2 shows 4 depictions of the same cylinder 202 with a piston 204 disposed therein. The water shift reactor is therefore a 4-stroke engine. The piston 204 is in communication with a rotary crank (not shown). The depictions of the cylinder include (1) an intake stroke (2) a compression stroke (3) a water shift stroke and (4) an exhaust stroke. The cylinder 202 has at least two ports—an inlet port and an outlet port. At the beginning of the intake stroke, the piston is at the top dead center (with a crank angle of about 0 degrees) and either syngas (e.g., a composition comprising primarily carbon monoxide and hydrogen), carbon monoxide or methane are injected and/or drawn to the cylinder 202. As can be seen in the FIG. 2, the intake stroke continues till the bottom dead center (BDC) is reached and the crank angle is about 180 degrees. The compression stroke commences after the intake stroke. During the compression stroke, the piston moves from the bottom dead center to the top dead center and causes compression and mixing of gases present in the cylinder. During the water shift stroke the piston moves from the top dead center to the bottom dead center and steam and/or water are injected or drawn into the cylinder near the top of the stroke along with an optional catalyst. During the water shift stroke, the water shift reaction commences. The water shift reaction results in a conversion of carbon monoxide and/or methane into carbon dioxide.

The exhaust stroke commences after the water shift stroke. During the exhaust stroke, carbon dioxide, hydrogen and water, which are the products and by-products of the water shift reaction are ejected from the cylinder via the exhaust port. The process is repeated over and over again converting carbon monoxide and/or methane into carbon dioxide.

While the above depiction shows water being injected/drawn into the cylinder during the water shift stroke, it is also possible to inject water and/or steam into the cylinder during the intake stroke or compression stroke. If water is introduced into the cylinder during the first and the third stroke instead of steam, the conversion of this water into steam (as a result of the high temperature within the cylinder) provides cranking pressure. In another embodiment, the injection of water into the cylinder removes heat from the walls of the cylinder and from the piston thereby providing self-cooling to the cylinder. The injection of water into the cylinder may make the presence of a radiator redundant. In other words, a radiator may not be used as a result of self-cooling provided by the water.

The improved water gas shift reaction mixing process (which takes place between the carbon monoxide, methane, syngas, or mixtures thereof) and steam begins with the start of water or steam injection into carbon monoxide. This takes place during the early stages of the water gas shift reaction stroke. The elevated pressure and temperature of the carbon monoxide, methane or syngas due to the compression stroke can be advantageously used to facilitate an improved water gas shift reaction with the water or steam. The systems performance can be tuned by varying these parameters to suit specific catalysts or the absence of catalysts by varying time, temperatures, and pressure. To avoid cross-flow of gases between the various strokes of the water gas shift reactor, the exhaust valve is timed to close before the intake valve opens.

The performance of the reciprocating water shift reactor can be adjusted to accommodate various catalysts and reactants. For example, if the water shift reaction is assumed to take place in half a stroke (i.e., the water shift stroke), the reciprocating engine speed can be about 0.5 revolutions per minute to about 30 revolutions per minute, specifically about 1 revolution per minute to about 25 revolutions per minute and more specifically about 1.5 revolutions per minute to about 15 revolutions per minute. The water gas shift reactor may also be in physical communication with another engine, such as for example, a reciprocating hydrogen engine, a fuel cell, a hydrogen fueled turbine, a rotary hydrogen combustion engine.

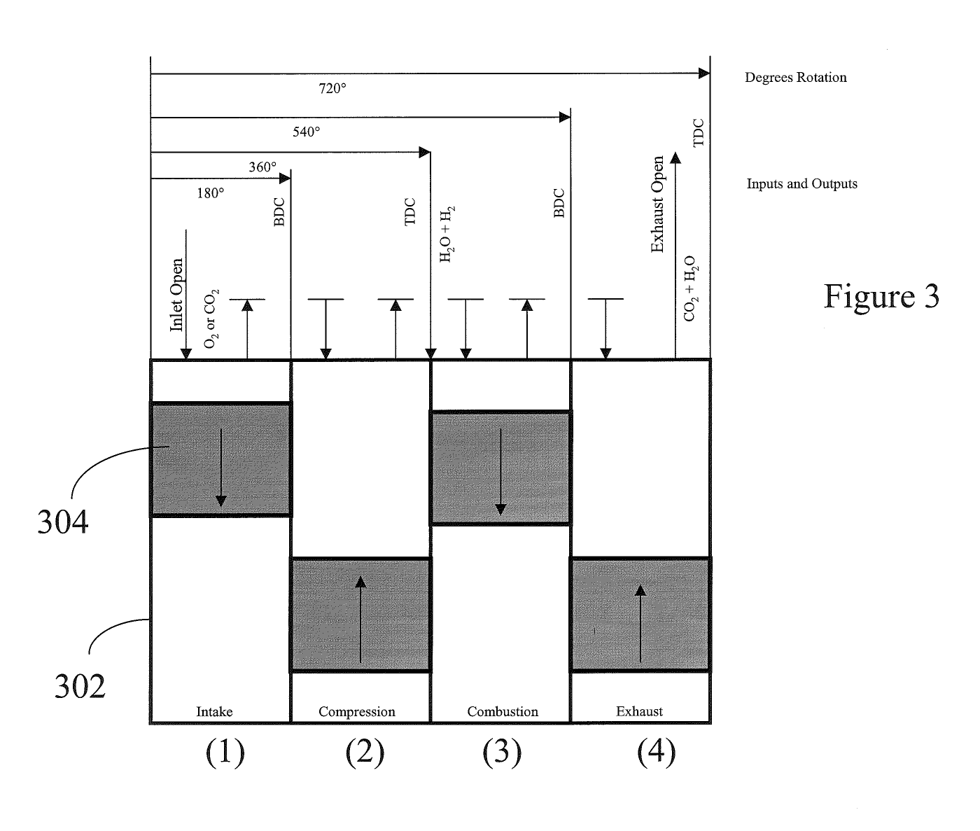

The FIG. 3 discloses a reciprocating hydrogen engine for the conversion of hydrogen obtained from either the gasifier or the water shift reactor into water. The hydrogen engine generally combines hydrogen with oxygen to produce water. A catalyst may be used to increase the rate of reaction.

The FIG. 3 shows 4 depictions of the same cylinder 302 with a piston 304 disposed therein. The piston 304 is in communication with a rotary crank (not shown). The depictions of the cylinder include (1) an intake stroke (2) a compression stroke (3) a combustion stroke and (4) an exhaust stroke. The hydrogen engine is therefore a 4-stroke engine. The cylinder 302 has at least two ports—an inlet port and an outlet port. At the beginning of the intake stroke, the piston is at the top dead center (with a crank angle of about 0 degrees) and a mixture comprising oxygen and carbon monoxide are injected and/or drawn to the cylinder 302. The oxygen and carbon dioxide may be drawn from the synthesis reactor (e.g., the algae bioreactor). As can be seen in the FIG. 3, the intake stroke continues till the bottom dead center (BDC) is reached and the crank angle is about 180 degrees. The compression stroke commences after the intake stroke. During the compression stroke, the piston moves from the bottom dead center to the top dead center and causes compression and mixing of gases present in the cylinder. During the combustion stroke the piston moves from the top dead center to the bottom dead center and steam and/or water along with hydrogen are injected or drawn into the cylinder along with an optional catalyst. During the combustion stroke, the reaction between hydrogen and oxygen to produce water commences.

The exhaust stroke commences after the combustion stroke. During the combustion stroke, carbon dioxide and water, which are the products and by-products of the water shift reaction are ejected from the cylinder via the exhaust port. The process is repeated over and over again converting hydrogen and oxygen into water.

While the above depiction shows water and/or hydrogen being injected/drawn into the cylinder during the combustion stroke, it is also possible to inject water and/or hydrogen into the cylinder during the intake stroke.

In one embodiment, if water is introduced into the cylinder during the first and the third stroke instead of steam, the conversion of this water into steam (as a result of the high temperature within the cylinder) provides cranking pressure. In another embodiment, the injection of water into the cylinder removes heat from the walls of the cylinder and from the piston thereby providing self-cooling to the cylinder. The injection of water into the cylinder may make the presence of a radiator redundant. In other words, a radiator may not be used as a result of self-cooling provided by the water.

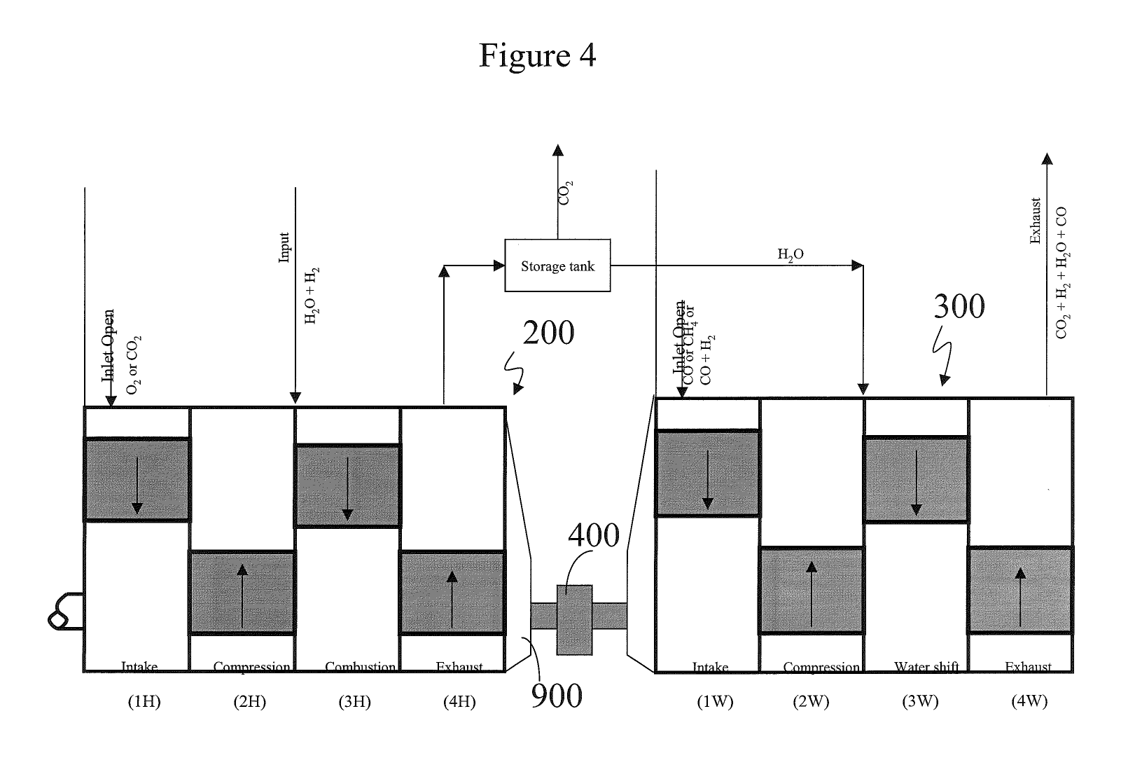

The FIG. 4 is a depiction of the 4-stroke water shift reactor of the FIG. 2 being in operative communication with the 4-stroke hydrogen engine of the FIG. 3. The water shift reactor is in mechanical communication with the hydrogen engine via a shaft 400 and a coupling device such as, for example, a clutch. The clutch may be used to establish or de-establish communication between the hydrogen engine and the water shift reactor. A speed reduction mechanism 900 (e.g., a gear-box) may also be used to establish communication between the water shift reactor and the hydrogen engine. The gear-box may be used to vary the ratio of the number of strokes in the water shift reactor to the number of strokes in the hydrogen engine, thereby permitting efficient conversion of the carbon monoxide into carbon dioxide in the water shift reactor and efficient conversion of hydrogen and oxygen in the hydrogen engine into water.

The hydrogen engine 200 and the water gas shift reactor 300 each operate using 4 strokes. The 4 strokes of the hydrogen engine are listed as 1H, 2H, 3H and 4H respectively, while the four strokes of the water gas shift reactor are listed as 1W, 2W, 3W and 4W respectively. These are detailed as follows. The 1H stroke represents the intake stroke of the hydrogen engine 200. Oxygen and carbon dioxide are drawn into the engine. In an exemplary embodiment, carbon dioxide is drawn into the engine. Stoke 2H represents the compression stroke of the hydrogen engine. During this stroke the temperature of the contents of the cylinder increases as a result of the compression. Near the end of the stroke 2H, hydrogen and water/steam is introduced into the cylinder. The hydrogen and water/steam may be injected into the cylinder. The water may be in the form of a spray, which provides cooling to the cylinder.

Stroke 3H represents the combustion stroke of the hydrogen engine. During this stroke, both valves are closed and combustion of the hydrogen with oxygen takes place. Stroke 4H is the hydrogen engine exhaust stroke. During this stage the piston moves up to exhaust the products of combustion, which are carbon dioxide and steam. The carbon dioxide is being recycled.

The products of the hydrogen engine may be sent to an optional storage tank from where some of the product may be sent to the water shift reactor, while the remainder may be separated off. In one embodiment, water from the storage tank may be sent to the water shift reactor.

The strokes of the water gas shift reactor are listed as 1W, 2W, 3W and 4W respectively. Stroke 1W is the intake stroke during which either carbon monoxide, methane, syngas, or a combination thereof are introduced into the cylinder. The intake manifold port is oriented to be approximately tangential to the piston bore and promotes a rotary gas swirl above the piston.

Stroke 2W is a compression stroke at the end of which water is introduced into the cylinder. The water may be injected into the cylinder by an injector located at the head of the cylinder. The water jets from the injector are directed across the rotating carbon dioxide flow above the piston. The jets are oriented to effectively mix the water with the carbon monoxide, methane or syngas and to contact any catalyst introduced into the cylinder. The catalyst may be attached to the top of the cylinder or may be introduced into the cylinder in powder form or liquid form with the water, carbon monoxide, methane or syngas.

Stroke 3W is the water gas shift reaction stroke during which carbon monoxide, methane, syngas and steam react and are converted into carbon dioxide and hydrogen. In the stroke 4W, which represents the exhaust stroke, the products and by-products of the water gas shift reaction (e.g., carbon dioxide and hydrogen) are pumped out of the engine. The cycle in both the hydrogen engine and the water gas shift reactor are both repeated.

With further reference to the FIG. 4, it may be seen that the use of the speed reduction mechanism 900 enables the hydrogen engine to be smaller and to operate at higher speeds. The exhaust from the hydrogen engine (e.g., steam and carbon dioxide) is supplied to the reciprocating water gas shift reactor towards the end of exhaust stroke of the hydrogen engine.

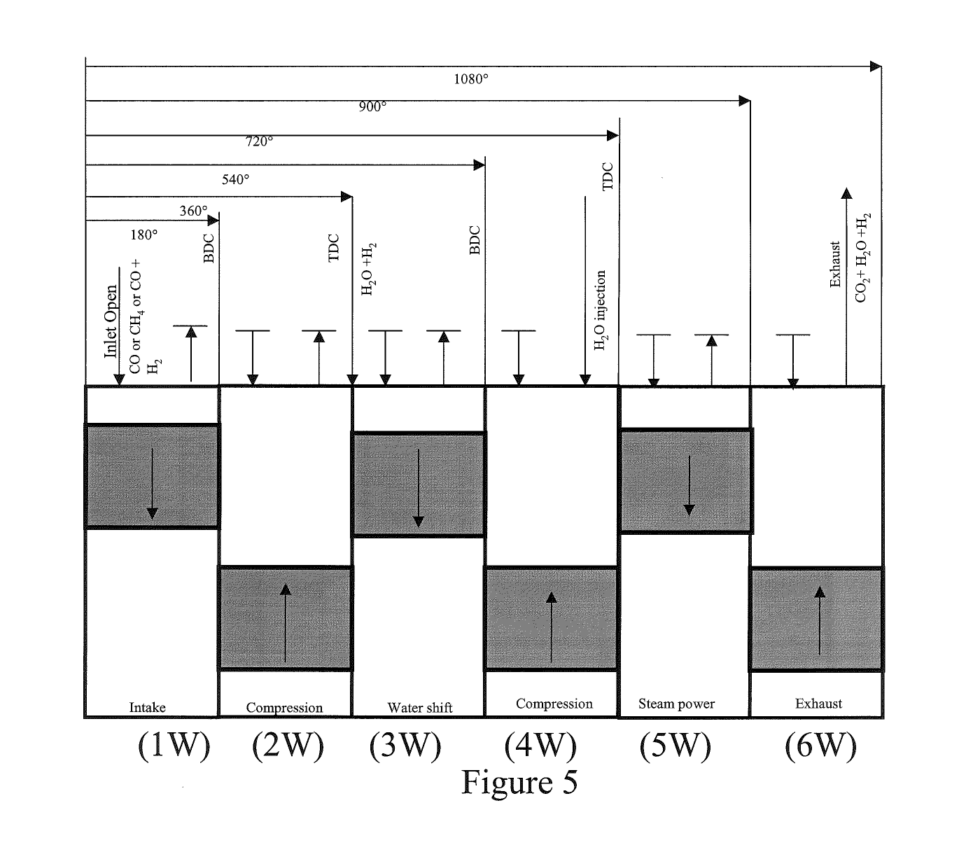

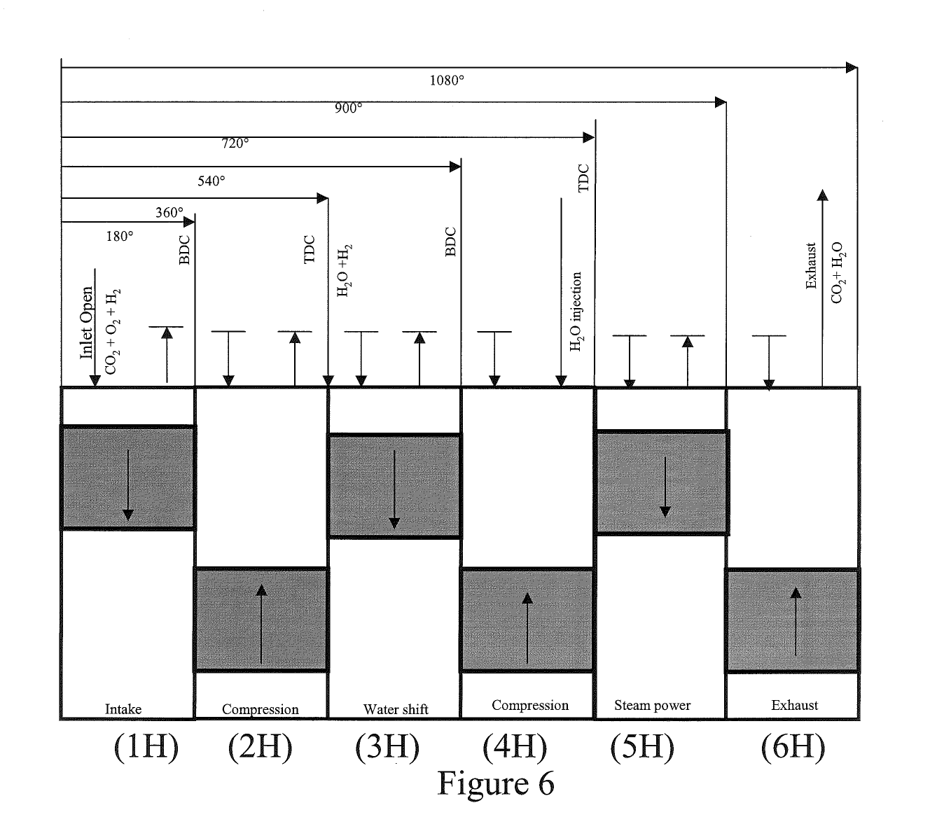

The FIGS. 5 and 6 represent a 6-stroke water gas shift reaction engine and a 6-stroke hydrogen engine respectively. By increasing the number of strokes from 4-strokes as depicted in the FIGS. 2 and 3 to 6-strokes, it is possible to increase the amount of mixing between the reactants to facilitate a better and more complete reaction between these reactants. For example, in the FIG. 5 water injection is conducted in the strokes 2W and 4W respectively, thereby allowing for the introduction of additional water into the cylinder to facilitate additional reaction between the carbon dioxide and the water. The two additional strokes are the 4W stroke and the 5W stroke. The 4W stroke is the compression stroke during which water is injected into the cylinder and the 5W stroke is the expansion stroke where the water absorbs heat from the cylinder and the piston to form steam. It is therefore referred to as the steam stroke. The six strokes (1-6W) of the water gas shift reactor are represented by a single cylinder in the FIG. 5. By injecting the water twice into the cylinder, additional cooling may be provided to the cylinder. The provision of two extra strokes (when compared with the 4-stroke engine of the FIG. 2) thus allows for better mixing between the reactants, better cooling of the piston and the cylinders and eventually a better reaction between the reactants.

The FIG. 6 depicts a 6-stroke hydrogen engine where water is injected to the cylinder in the stroke 2H and 4H respectively. The six strokes (1-6H) of the hydrogen engine are represented by a single cylinder in the FIG. 6. By injecting the water twice into the cylinder, additional cooling may be provided to the cylinder. The provision of two extra strokes (when compared with the 4-stroke engine of the FIG. 3) thus allows for better mixing between the reactants, better cooling of the piston and the cylinders and eventually a better reaction between the reactants. The two additional strokes (over that depicted in the FIG. 3) are the compression stroke 4H and the steam power stroke 5H. The function of the compression stroke 4H is to transfer energy from the exhaust gas and cylinder walls, to steam, and use the steam for the steam power stroke 5H. During the compression stroke 4H, water is sprayed into the combustion chamber walls and the top of the piston to form steam. This absorbed heat is then released during the steam power stroke 5H. This is similar to the process in the water gas shift reactor.

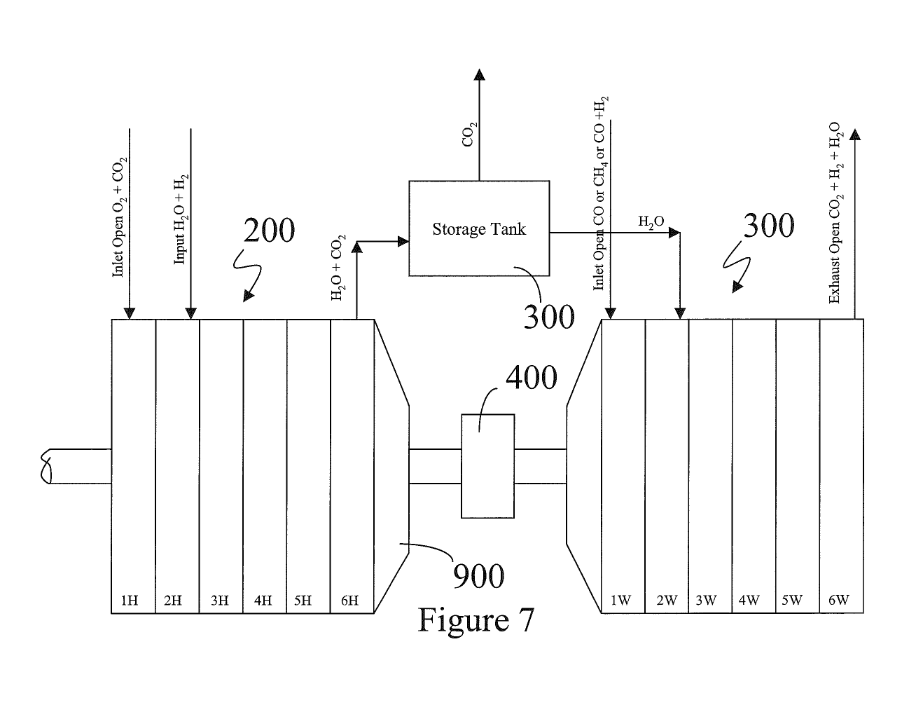

The FIG. 7 depicts a 6-stroke hydrogen engine in communication with a 6-stroke water gas shift reactor. The 6-strokes of the hydrogen engine are represented by 1-6H, while the 6-strokes of the water shift reactor are represented by 1-6W. The FIG. 7 depicts a single cylinder of the hydrogen engine and the water shift reactor through 6 different strokes. The 6-stroke hydrogen engine functions in a manner similar to that described in the FIG. 6, while the 6-stroke water gas shift reactor functions in a manner similar to that described in the FIG. 5. The storage tank 300 in communication with the hydrogen engine and the water gas shift reactor stores the output from the hydrogen engine (e.g., water and carbon dioxide). The carbon dioxide can be separated from the water in the storage tank. The water can then be discharged to the water gas shift reactor.

As noted above, with regard to the FIG. 4, the hydrogen engine and the water gas shift reactor of the FIG. 7 are in communication with one another via a coupling (e.g., a clutch, a gear box, or a combination thereof) that permits the two engines to be decoupled from each other and also permits a the two engines to operate at different speeds.

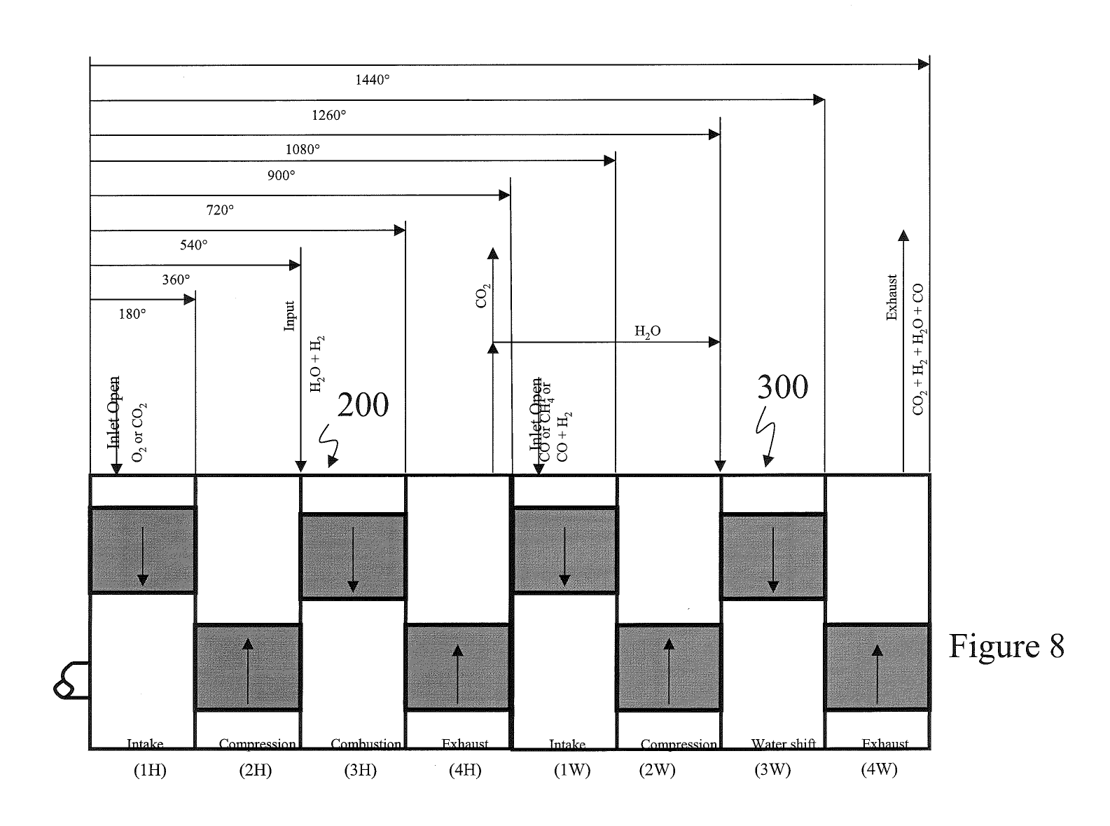

In one embodiment, a single cylinder can serve as a 4, 6 or 8 stroke reciprocating hydrogen engine and water gas shift reactor as well. The FIG. 8 depicts a single cylinder that can serve as a 4 stroke hydrogen engine and a 4 stroke water gas shift reactor in sequence. As can be seen in the FIG. 8, the first four strokes (1-4H) are those due to the hydrogen engine, while the next 4 strokes (1-4W) are those due to a water shift reactor respectively. In this configuration, the steam exhausted from the hydrogen engine supplies the water requirements of the water gas shift reactor.

The single cylinder hydrogen engine and water gas shift reactor of the FIG. 8 functions in a manner similar to the device of the FIG. 7, except for the fact that a single cylinder is used to perform both hydrogen engine and water shift gas reactor functions. Here too the water output from the hydrogen engine forms the input for the water gas shift reactor. The water and carbon dioxide from the hydrogen engine is stored in storage tank, where the water is separated from the carbon dioxide. The water is then fed to the water gas shift reactor. The reciprocating water gas shift reactor is therefore an integral single cylinder four stroke reciprocating hydrogen engine and an integral single cylinder 4-stroke reciprocating water gas shift reactor.

While the single cylinder device of the FIG. 8 is depicted as using 4 strokes for both hydrogen engine and water gas shift reactor functions respectively, it can be envisioned that both the hydrogen engine and the water gas shift reactor uses 6 or more strokes respectively, 6 or more strokes respectively, 8 or more strokes respectively, 10 or more strokes respectively or 12 or more strokes respectively. In one embodiment, while the hydrogen engine uses 4 strokes, the water gas shift reactor may use 6 or more strokes respectively, 8 or more strokes respectively, 10 or more strokes respectively or 12 or more strokes respectively. In another embodiment, while the hydrogen engine uses 6 strokes, the water gas shift reactor may use 6 or more strokes respectively, 8 or more strokes respectively, 10 or more strokes respectively or 12 or more strokes respectively. In yet another embodiment, while the hydrogen engine uses 8 strokes, the water gas shift reactor may use 6 or more strokes respectively, 8 or more strokes respectively, 10 or more strokes respectively or 12 or more strokes respectively. In yet another embodiment, while the hydrogen engine uses 10 strokes, the water gas shift reactor may use 6 or more strokes respectively, 8 or more strokes respectively, 10 or more strokes respectively or 12 or more strokes respectively. In yet another embodiment, while the hydrogen engine uses 12 strokes, the water gas shift reactor may use 6 or more strokes respectively, 8 or more strokes respectively, 10 or more strokes respectively or 12 or more strokes respectively.

While the devices shown in the FIGS. 2-8 are single cylinder devices, it is desirable to use multi-cylinder devices. Multi-cylinder devices are advantageous in that they enable greater design and operating freedom.

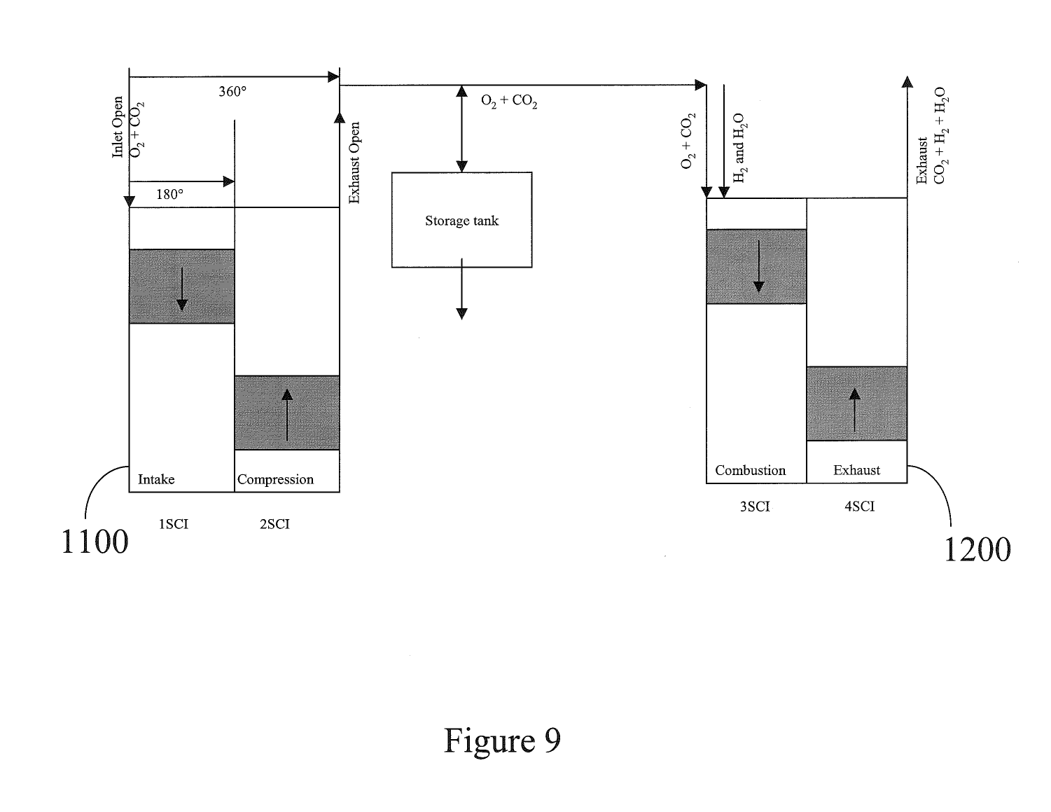

The FIG. 9 depicts a split stroke water gas shift reactor. The split stroke devices of the FIG. 9 operate on a two stroke cycle. In the FIG. 9, the water gas shift reactor is depicted as having an upstream cylinder 1100 (compression cylinder) and a downstream cylinder 1200 (combustion cylinder). The compression strokes are conducted in the upstream cylinder 1100 while the combustion and exhaust strokes are conducted in the downstream cylinder 1200. In this exemplary embodiment, the intake and compression cylinder (i.e., the upstream cylinder 1100) operates at a much higher compression ratio than the combustion and the exhaust cylinder (i.e., the downstream cylinder 1200). This provides vigorous mixing promoted by the high pressure input gas which shortens the ignition delay. The details of each stroke are as follows:

Stroke 1SCI or the intake stroke. The piston 204 moves down (away from the top dead center) to draw in carbon dioxide and oxygen through the inlet port, which may be obtained from the synthesis reactor. During the compression stroke (Stroke 2SCI), both the inlet and exhaust ports are closed and the gases in the cylinder are compressed thereby increasing their pressure and temperature. The outlet port is opened slightly after the piston reaches the top dead center thereby exhausting the cylinder to the feed tank and to the downstream cylinder 1200.

Stroke 3SCI is the hydrogen engine combustion stroke which takes place in the cylinder 1200. With both the inlet and the outlet ports closed, the piston moves down towards the bottom dead center and the combustion of hydrogen and oxygen to produce water takes place. Stroke 4SCI follows stroke 3SCI and is the exhaust stroke. With the inlet port closed, the outlet port is opened and the piston moves from the bottom dead center to the top dead center. The products of combustion notably carbon dioxide and steam are exhausted from the cylinder. In the FIG. 9, the intake stroke (1SCI) and the compression stroke (2SCI) operate simultaneously with the previous combustion stroke (3SCI) and the exhaust stroke (4SCI). This enables the combustion stroke as a two-stroke component of the 4-stroke cycle.

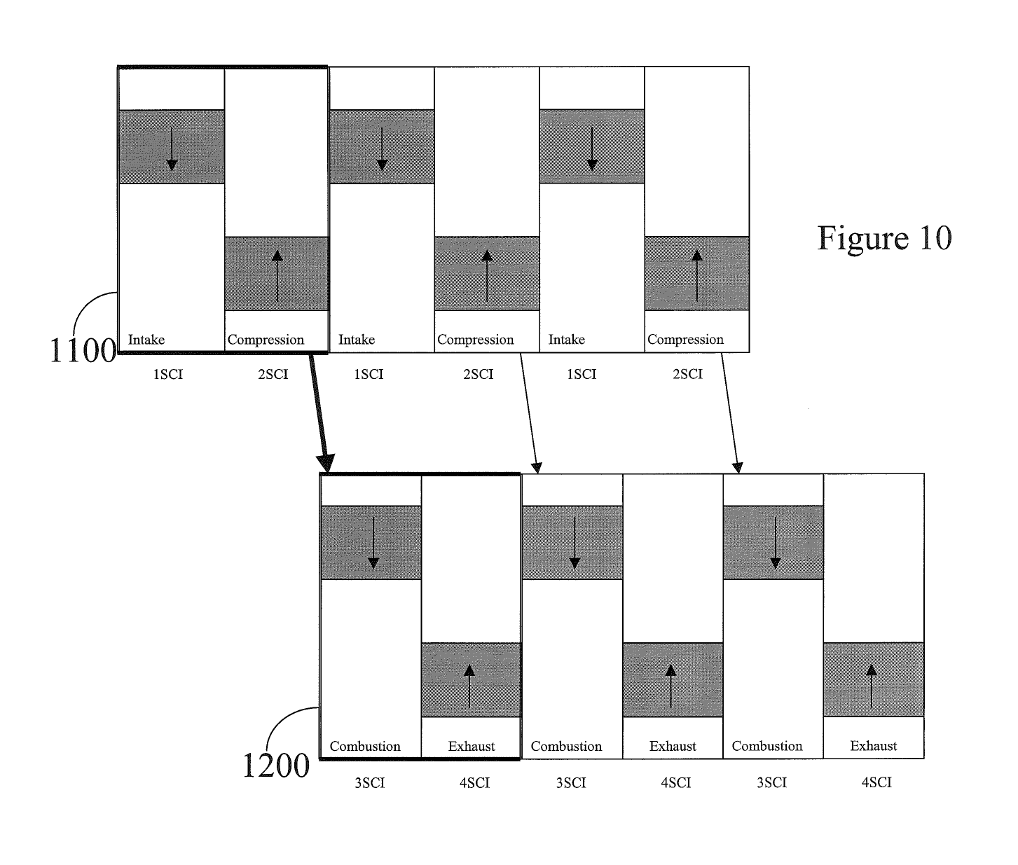

In one embodiment, a plurality of upstream cylinders (compression cylinders) may be placed in communication with a plurality of downstream cylinders (combustion cylinders). This set up is depicted in the FIG. 10, where a plurality of two stroke upstream cylinders 1100 are in communication with a plurality of two stroke downstream cylinders 1200. The device depicted in the FIG. 10 works in a similar manner to the device depicted in the FIG. 9. In the FIG. 10, each pair of upstream cylinders communicates with a pair of downstream cylinders. In other words, the output from the first pair of upstream cylinders is directed to the first pair of downstream cylinders (shown in darkened outline in the FIG. 10), while the output from the second pair of upstream cylinders is directed to the second pair of downstream cylinders, and so on. In the device shown in the FIG. 10, the intake stroke 1SCI and the compression stroke 2SCI operate simultaneously with the previous combustion stroke 3SCI and the exhaust stroke 4SCI. This enables the combustion stroke 3SCI to follow stroke 2SCI as a two stroke component of the 4 stroke cycle.

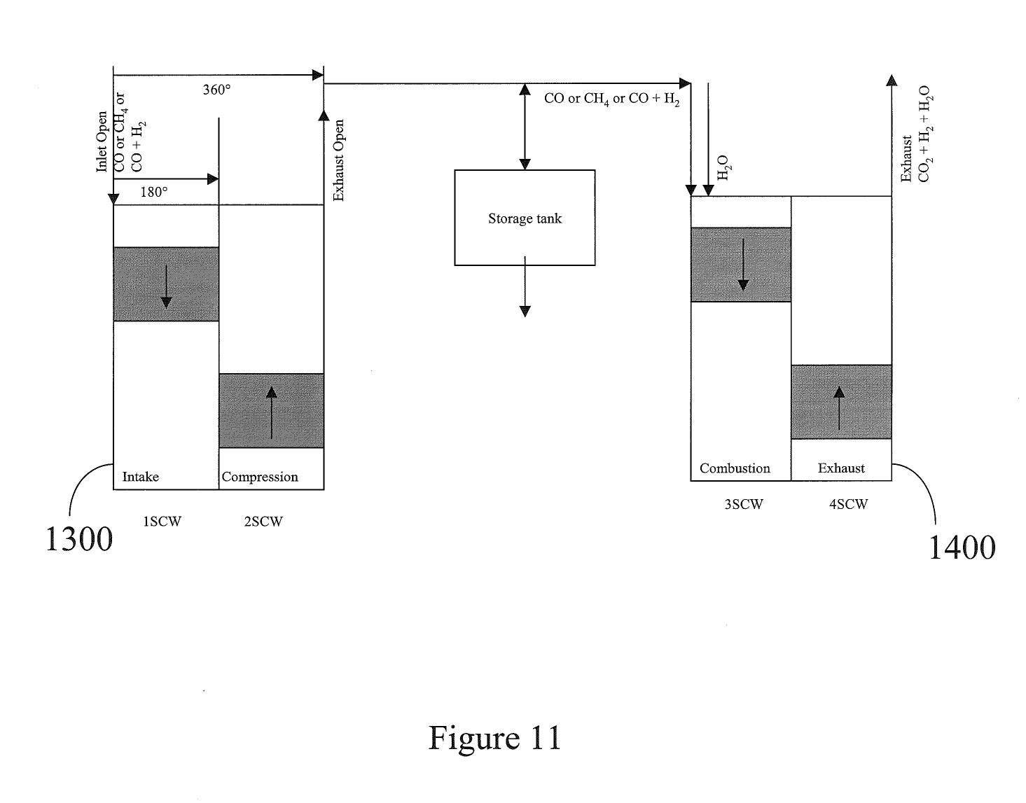

The FIGS. 11, 12 and 13 depict another variation on the two stroke water shift reactor. In the FIG. 11, the four stroke reciprocating water gas shift reactor cycle is split into 2 cylinders, each of which operate on a two stroke cycle. The intake and compression strokes are carried out in the upstream cylinder (Item 1300) and the combustion and exhaust in the downstream cylinder (Item 1400). Splitting the cycle into 2 cylinders enables greater design freedom. In this embodiment, the intake and the compression cylinder (item 1300) operates at a much higher compression ratio than the combustion and exhaust cylinder (Item 1400). By advancing the timing of the combustion cylinder, highly pressurized gas from the stroke 2SCW is fed later in the cycle 3SCW, the water gas shift reaction stroke. The vigorous mixing promoted by the high pressure intake gas shortens the water gas shift reaction time.

Although the two cylinders (Item 1300) and (Item 1400) operate simultaneously on two stroke cycles, the four strokes explained below are listed in the four stroke cycle sequential order. The details of each stroke are:

Stroke 1 SCW of the intake stroke involves the drawing of either carbon monoxide, methane or syngas into the cylinder 1300. Stroke 2SCW or the compression stroke involves compressing either the carbon monoxide, methane or syngas in the cylinder. This increases the pressure and temperature of the gases inside the cylinder. The pressurized gases are fed to the either to the tank 1000 or the cylinder 1400 or both.

Stroke 3SCW is the water gas shift reaction stroke. In this stroke, which occurs in the cylinder 1400, the outlet port is closed and the inlet valve opens shortly before the piston reaches top dead center and closes shortly after the piston reaches top dead center. The piston moves down and water spray or steam jets are directed into the rotating carbon monoxide or methane or syngas flow in the chamber above the piston. The jets are oriented and spaced to effectively mix with the carbon monoxide, methane or syngas and have fluid contact with the catalyst. The catalyst may be attached to the top of the piston or be in fluid or powder form within the water or steam, carbon monoxide, methane or syngas. The carbon monoxide, methane or syngas are converted into carbon dioxide and hydrogen.

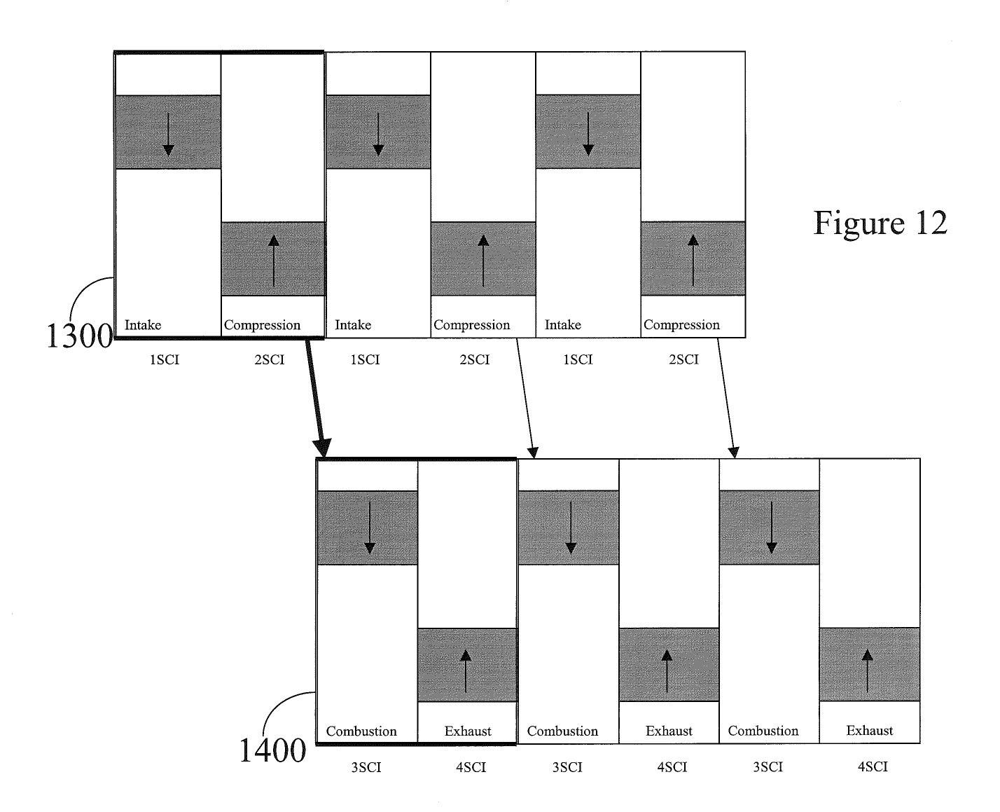

Stroke 4SCW or the exhaust stroke. This stroke takes place in the cylinder 1400. With the inlet port closed and the outlet port open, the piston moves up. The water gas shift reaction products are pumped out of the engine. As shown in the FIG. 12, the intake stroke 1SCW and the compression stroke 2SCW operate simultaneously with the combustion stroke 3SCW and exhaust stroke 4SCW. This enables stroke 3SCW to follow stroke 2SCW as a two stroke component of the 4 stroke cycle.

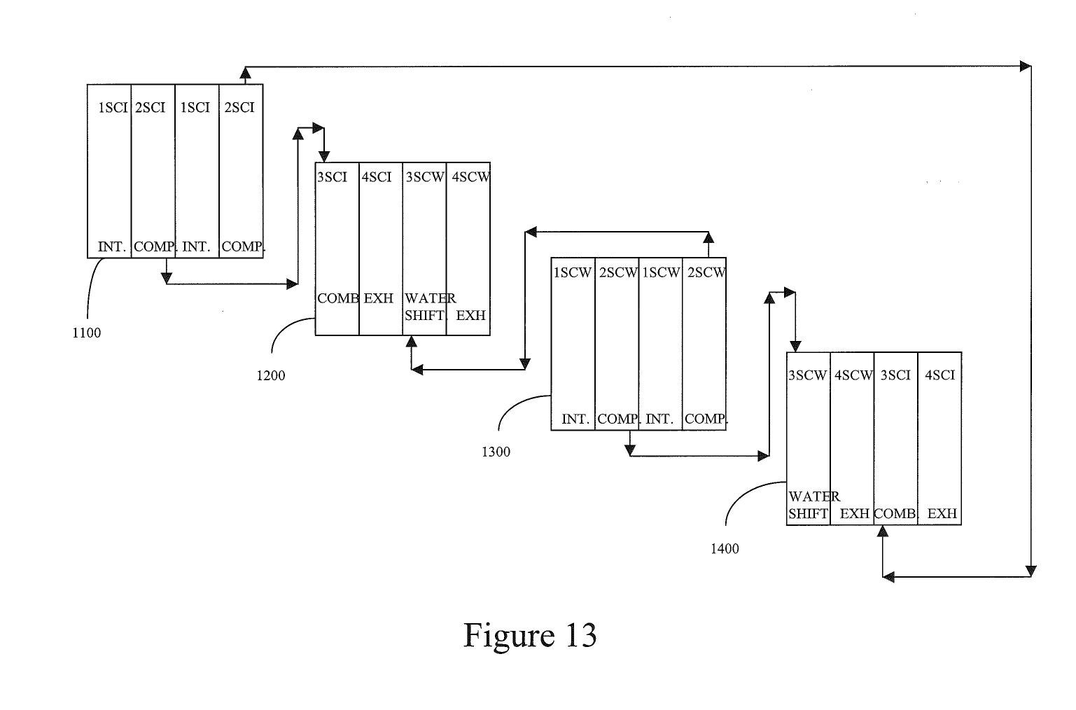

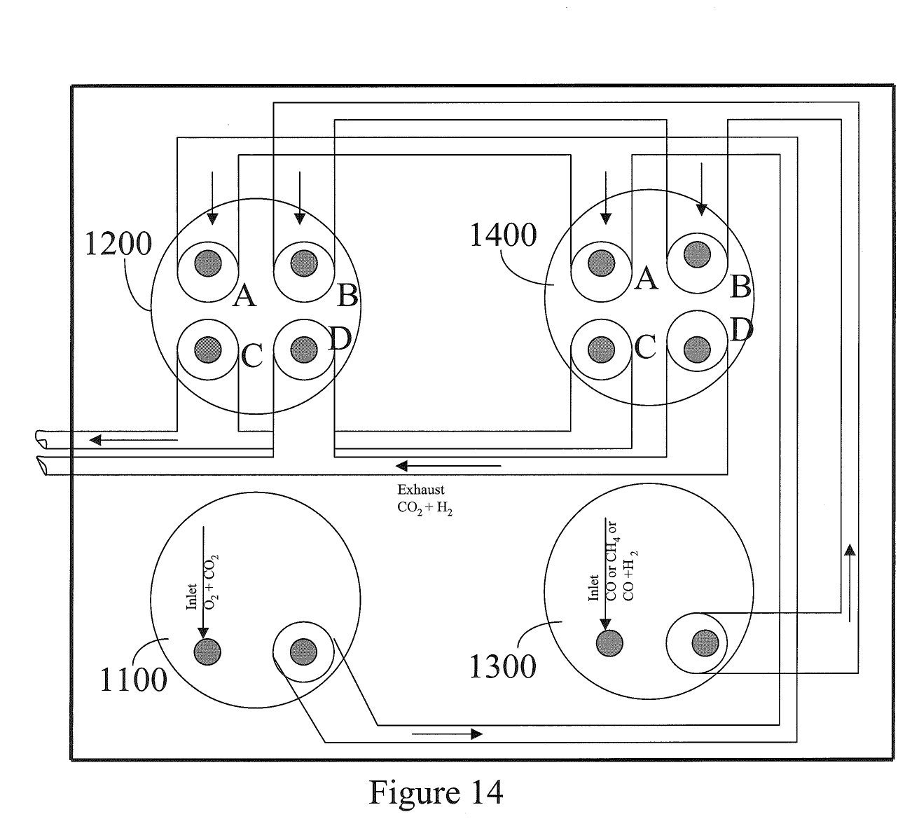

Operating the internal combustion engine as a stand alone unit suffers from the disadvantage of a combustion stroke taking place every revolution. This causes a heat build up in the cylinder, which is undesirable. In the embodiments depicted in the FIGS. 13 and 14, this can be avoided by using 2 pairs of cylinders, one operating as an internal combustion engine and the other operating at a lower temperature as the water gas shift reactor engine. As may be seen in the FIG. 14, by using a four valve cylinder head (cylinders 1200 and 1400 respectively) fed by dedicated supply cylinders (item 1100 and 1300 respectively) for the internal combustion engine and the water gas shift reaction respectively, the cylinders can operate firstly with the intake and exhaust valves “A” operative as the internal combustion engine and the next revolution with the intake and exhaust valves “B” operative as the water gas shift reactor engine.

In the FIG. 14, oxygen and carbon dioxide from the algae bioreactor are compressed in the cylinder 1100 while at the same time carbon monoxide, methane, syngas or combinations thereof from the plasma gasifier are compressed in the cylinder 1300. The respective compressed gases are then fed to cylinders 1200 and 1400 through inlet valves A and B respectively. The water gas shift reaction is then performed in the cylinders 1200 and 1400 respectively and the final product comprising carbon dioxide and hydrogen are removed from the cylinders 1200 and 1400 via the outlet ports C and D respectively. The engine is thus operative as a dual cylinder six stroke split cycle as shown in the FIG. 13, with the complete cycle lasting 3 engine revolutions. In one embodiment, where a conventional mechanical camshaft is used to operate the valves, the camshaft would rotate at one third the engine speed.

The details of the strokes for the FIG. 13 are listed below. Stroke 1SCI is the intake stroke for the cylinder (1100). The piston moves down during the intake stroke and the outlet port is closed. Once the cylinder pressure drops below the pressure at the inlet port, oxygen and carbon dioxide gases are drawn into the cylinder. The inlet valve is opened for the remainder of the stroke.

Stroke 2SCI is the compression stroke for the cylinder (1100). The inlet and outlet ports are closed. The compression of the gas increases the temperature and pressure of the gases. The outlet port opens towards the end of the stroke until shortly after the piston reaches the top dead center. This feeds the tank 1000 and the cylinder 1200.

Stroke 3SCI is the combustion stroke for the cylinder 1200. The cylinder (1200) is fed from the cylinder (1100). With the exhaust valve closed, and the inlet valve opening just before the piston reaches the top dead center, and closing shortly after the top dead center, the piston moves down. An injector located in the engine cylinder head, sprays hydrogen and water (or steam) into the cylinder. The jets are oriented and spaced to effectively mix the hydrogen water (or steam) with the oxygen and carbon dioxide in the cylinder for good combustion. Combustion takes place immediately following the intake valve closing.

Stroke 4SCI is the exhaust stroke of the cylinder (1200). With the inlet valve closed and the exhaust valve open, the piston moves up. The products of combustion (carbon dioxide and steam) are pumped out of the cylinder.

The details of strokes for the cylinder (1300) and (1400) are as follows: Stroke 1SCW is the intake stroke of the cylinder (1300). The piston moves down for carbon monoxide or methane or syngas intake. The outlet port is closed. When the cylinder pressure drops below the inlet pressure, oxygen and the carbon dioxide enter the cylinder. The inlet valve is opened for the remainder of the stroke.

Stroke 2SCW is the compression stroke of the cylinder (1300). With the inlet and outlet ports closed, the piston moves up thereby compressing the gas. The exhaust valve opens towards the end of its stroke and closes shortly after piston reaches the top dead center. This increases the temperature and pressure of the cylinder gases.

Stroke 3SCW is the water gas shift reaction stroke for the cylinder (1400). The cylinder (1400) is fed by cylinder (1300). With both inlet and outlet ports closed the piston moves down. An injector, located in the engine cylinder head, directs water or steam jets (across the rotating carbon dioxide, or methane, or syngas) into the chamber above the piston. The jets are oriented and spaced to effectively mix with the carbon monoxide and have fluid contact with the catalyst. The catalyst may be attached to the top of the piston, or be in fluid or powder form within the water or the carbon monoxide, or methane, synthesis gas to be converted into carbon dioxide and hydrogen.

Stroke 4SCW is the exhaust stroke of the cylinder (1400). The cylinder (1400) is fed by cylinder (1300). With the inlet valve closed and the exhaust valve open, the piston moves up. The water gas shift reaction products (carbon dioxide, hydrogen, and steam) are pumped out of the engine.

As shown in FIG. 13 following these 4 strokes, both cylinders 1100 and Item 1300, switch so that power cylinder 1100 now supplies cylinder 1400 and power cylinder 1300 supplies cylinder 1200.

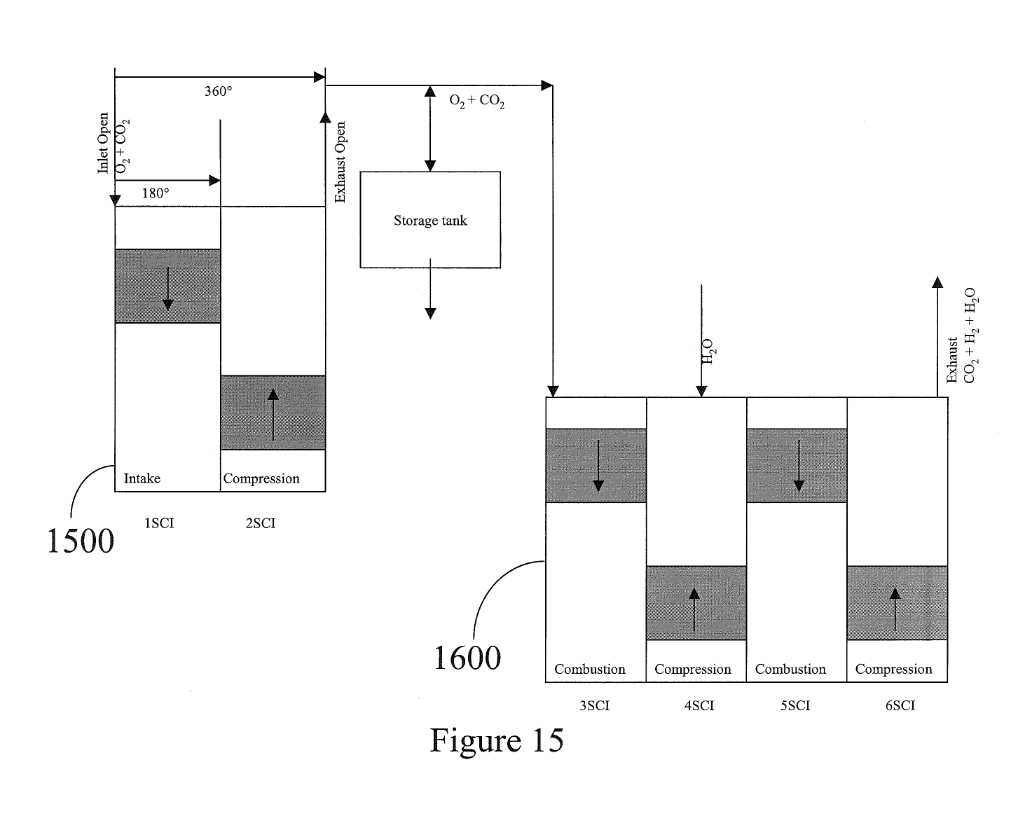

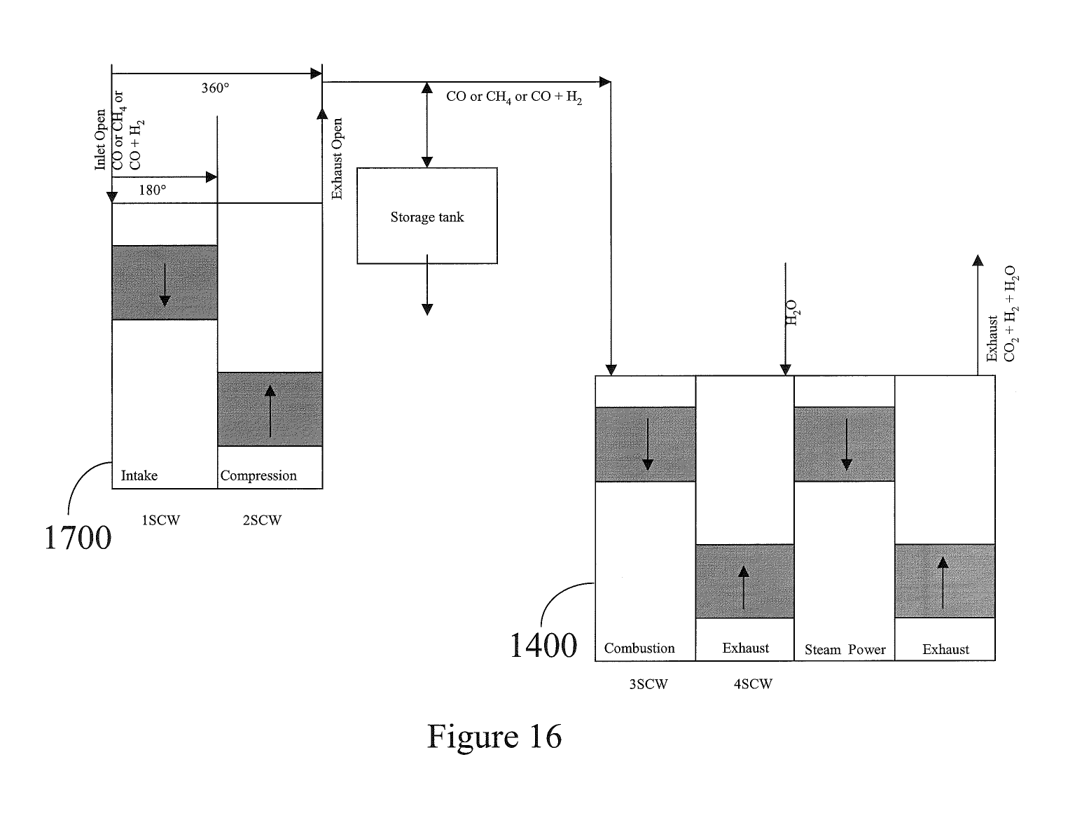

As a further refinement two additional strokes have been added to form a 6 stroke combustion and water gas shift reactor. This is depicted in the FIGS. 15 and 16. These comprise compression, and steam power strokes, 4SCI and 5SCI for the hydrogen internal combustion engine, and 4SCW and 5SCW for the water gas shift reactor. The exhaust stroke changes from stroke number 4 to stroke number 6. The function of compression stroke 4 is to obtain the energy in the exhaust gas and the cylinder walls, and recycle it for a steam power stroke (number 5SCI and 5SCW). During the compression stroke 4SCI and 4SCW, water is sprayed into the combustion chamber and the water gas shift reactor chamber, to absorb heat to form steam. This energy is then released during the following steam power stroke 5SCI and 5SCW.

Cylinders (1500 and 1700) and (1600 and 1800) operate simultaneously, as shown in the FIGS. 15, 16 and 17. This forms two 6 stroke cycles that take place in 5 engine revolutions. Listed below are the strokes in cycle sequential order. The details of the power stroke are:

Stroke 1SCI represents the intake stroke of the cylinder (1500) used for compression. The piston moves down with the inlet and outlet ports being closed. Once the cylinder pressure drops below the pressure of the inlet, oxygen and carbon dioxide are drawn into the cylinder with the inlet valve being opened for the remainder of the stroke.

Stroke 2SCI represents the compression stroke cylinder (1500). The piston moves up with the inlet and the outlet ports closed. This increases the temperature and pressure of the cylinder gases. The exhaust valve opens towards the end of the stroke until shortly after piston reaches the top dead center. This feeds tank 1000 and the cylinder 1600.

Stroke 3SCI is the combustion stroke of the cylinder (1600). The cylinder 1600 is fed by cylinder (1500). With the outlet port closed, and the inlet port opening just before piston top dead center (TDC), and closing shortly after TDC, the piston moves down. An injector located in the engine cylinder head, sprays hydrogen and water (or steam) into the cylinder. The hydrogen and water (or steam) jets are oriented and spaced to effectively mix with the oxygen and carbon dioxide in the cylinder for good combustion. Ignition and combustion takes place immediately following intake valve closing.

Stroke 4SCI represents the cylinder (1600) compression stroke. Both inlet and outlet ports remain closed. The piston moves up. Water is injected into the combustion chamber late in the stroke to form steam.

Stroke 5SCI represents the cylinder (1600) steam power stroke. Both inlet and outlet ports remain closed. Steam expansion provides an additional power stroke.

Stroke 6SCI represents the cylinder (1600) exhaust stroke. With the inlet port closed and the outlet port opened, the piston moves up. The products of combustion (carbon dioxide and steam) are pumped out of the engine.

The details water gas shift reaction strokes are as follows:

Stroke 1SCW is the cylinder (1700) intake stroke. The piston moves down for carbon monoxide or methane or synthesis gas intake. The outlet port is closed. When the cylinder pressure drops below the pressure of the inlet port, oxygen and carbon dioxide supply gases with the inlet port being opened for the remainder of the stroke.

Stroke 2SCW is the cylinder (1700) compression stroke. The piston moves up with the inlet and outlet ports closed. The outlet ports opens towards the end of its stroke and closes shortly after piston reaches the top dead center. This increases the temperature and pressure of the cylinder gases. This feeds tank 1000 and cylinder 1800.

Stroke 3SCW represents the water gas shift reaction stroke in the cylinder (1800). The cylinder (1800) is fed from the cylinder (1700). With both inlet and outlet ports closed, the piston moves down. A water injector, located in the engine cylinder head, directs water or steam jets outwards across the rotating carbon dioxide flow in the chamber above the piston. The jets are oriented and spaced to effectively mix with the carbon monoxide, or methane or syngas and have fluid contact with the catalyst. The catalyst may be attached to the top of the piston, or be in fluid or powder form within the water, and/or the carbon monoxide, and/or the methane, and/or the syngas to be converted into carbon dioxide and hydrogen. Alternatively the catalyst can be injected into the cylinder via a separate port.

Stroke 4SCW represents the cylinder (1800) compression stroke. Both inlet and outlet ports remain closed. The piston moves up. Water is injected into the combustion chamber late in the stroke to form steam.

Stroke 5SCW represents the cylinder (1800) steam power stroke. Both the inlet and the outlet ports remain closed. Steam expansion provides an additional power stroke.

Stroke 6SCW represents the cylinder (1800) exhaust stroke. With the inlet port closed and the outlet port open, the piston moves up. The water gas shift reaction products (carbon dioxide and hydrogen) are pumped out of the engine.

As shown in FIG. 16 following these 6 strokes, both cylinders 1500 and 1700, switch so that power cylinder 1500 now supplies cylinder 1800 and power cylinder 1700 supplies cylinder 1600.

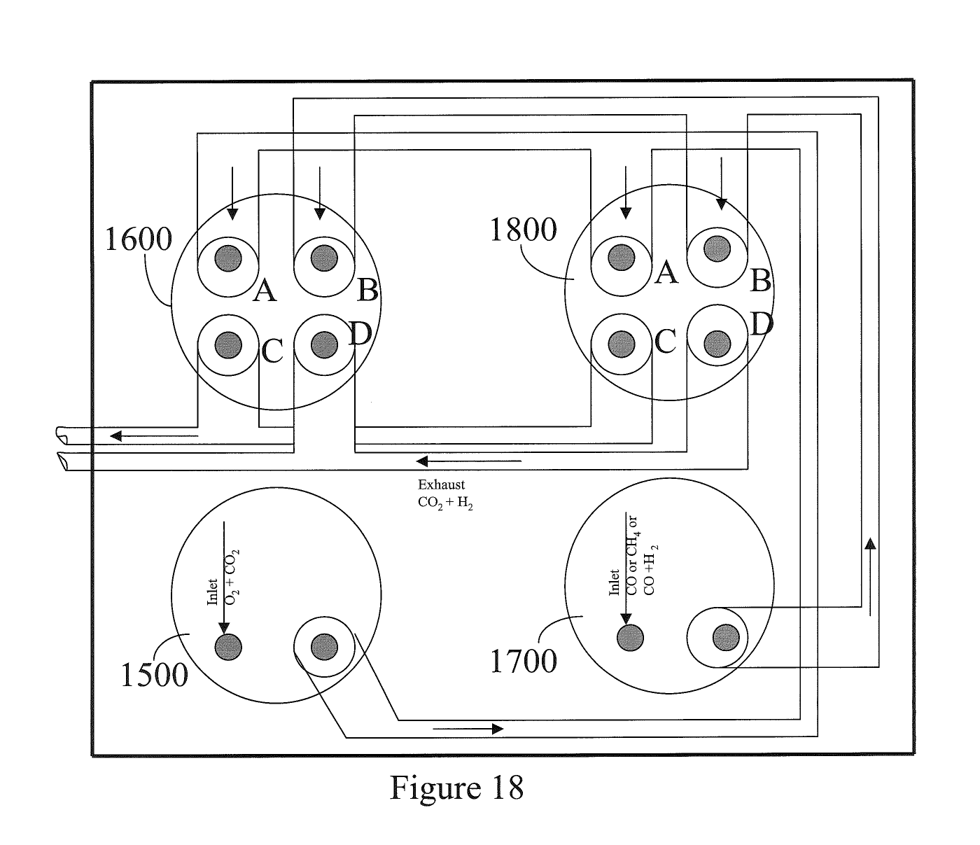

In the FIG. 18, oxygen and carbon dioxide from the algae bioreactor are compressed in the cylinder 1500 while at the same time carbon monoxide, methane, syngas or combinations thereof from the plasma gasifier are compressed in the cylinder 1700. The respective compressed gases are then fed to cylinders 1200 and 1400 through inlet valves A and B respectively. The water gas shift reaction is then performed in the cylinders 1600 and 1800 respectively and the final product comprising carbon dioxide and hydrogen are removed from the cylinders 1600 and 1800 via the outlet ports C and D respectively.

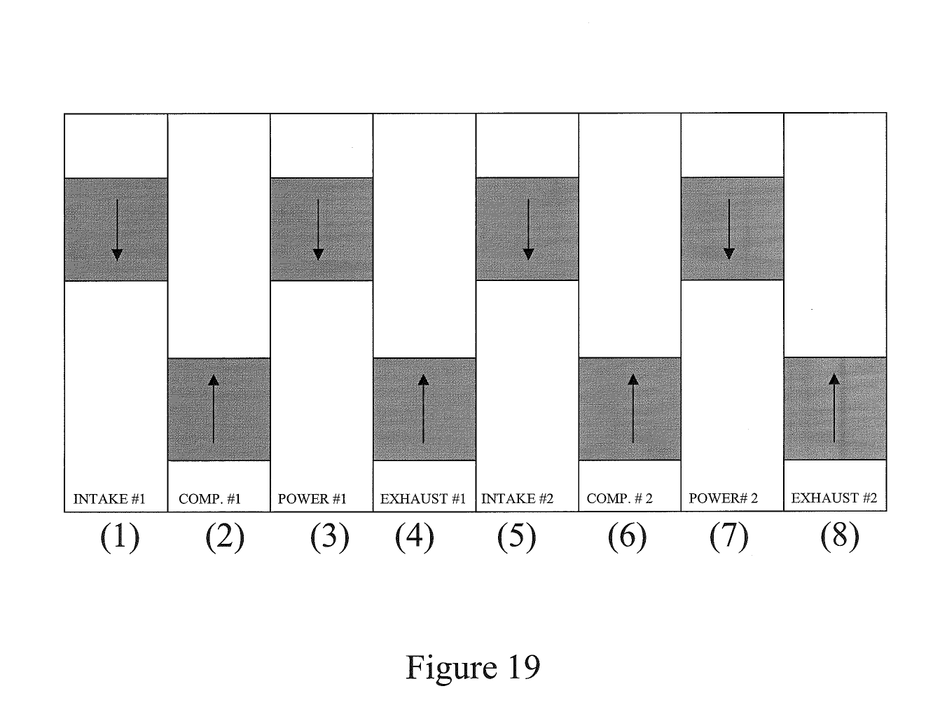

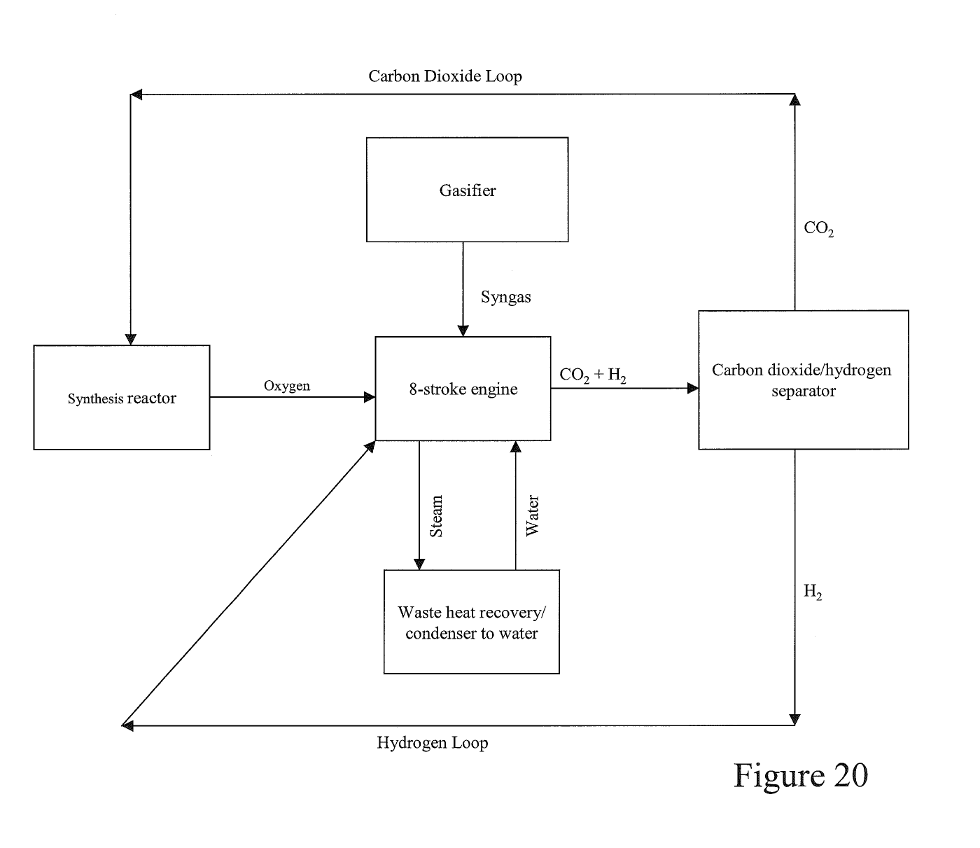

In another embodiment depicted in the FIGS. 19 and 20, an 8-stroke engine may be used as a water gas shift reactor to convert syngas from the gasifier to form carbon dioxide and hydrogen (see FIG. 20). The carbon dioxide and hydrogen are separated in a separator. The carbon dioxide may be supplied to a synthesis reactor (e.g., algae bioreactor) as part of a carbon loop. The hydrogen is part of a hydrogen loop and is combined with oxygen to produce water in the 8-stroke engine. Oxygen from the synthesis reactor is fed to the 8-stroke engine to be combined with the aforementioned hydrogen. Water is supplied to the 8-stroke engine to combine with the carbon monoxide that is eventually converted into carbon dioxide.

In the stroke #1 of FIG. 19, which serves as the intake stroke #1, hydrogen and oxygen are drawn in (may possibly be sourced from the synthesis reactor as seen in the FIG. 19). Since the oxygen is drawn in from the bioreactor, it contains only oxygen with little or no nitrogen. In compression stroke #1, the hydrogen and the oxygen are compressed. In the power stroke #1, the piston moves down from the force of expanding gases. Hydrogen and oxygen undergo combustion. In exhaust stroke #1, steam from the cylinder is exhausted and is condensed into water. In intake stroke #2, syngas is drawn into the cylinder. In the compression stroke #2, the syngas is compressed. The power stroke #2 (also known as the water gas shift reaction stroke) then ensues. During the water gas shift reaction stroke, syngas is converted to carbon dioxide and water. Water from exhaust stroke #1 is injected at the amount required the convert all the carbon in the syngas into carbon dioxide. During the exhaust stroke #2, the carbon dioxide and hydrogen and/or water from the cylinder are ejected from the cylinder. A coal slurry may be injected between strokes 5 and 6 if desired.

The use of an 8-stroke engine has numerous advantages. These are listed below. Oxygen plant parasitical loss can be completely eliminated, replaced by the bioreactor.
1) The hydrogen has a faster flame front than petroleum. This reduces piston down travel per given amount of energy released from fuel burned. The net result is a smaller volume per BTU released, hence greater cylinder pressure.
2) The higher the percentage of oxygen the faster the flame front. This also enables more complete fuel burn near top dead center.
3) The volume is reduced @ the top dead center as the nitrogen is not present as would be using atmospheric air. This also increases cylinder pressure.
4) The cooling water used during Stroke #2 and #3 expands approximately 200+ times providing greater amounts of gas within the same cylinder during power stroke #1. This once again increases cylinder pressure.
5) The cooling water of stroke #2 also equals hydrogen exported from the system after stroke #8. This means that system cooling equals the system hydrogen export.
6) Stroke #7 takes a parasitical loss (the WSR) and instead creates a second power stroke (stroke #7) from it.
7) By utilizing the engine and syngas waste heat for the water shift reaction efficiency is increased.

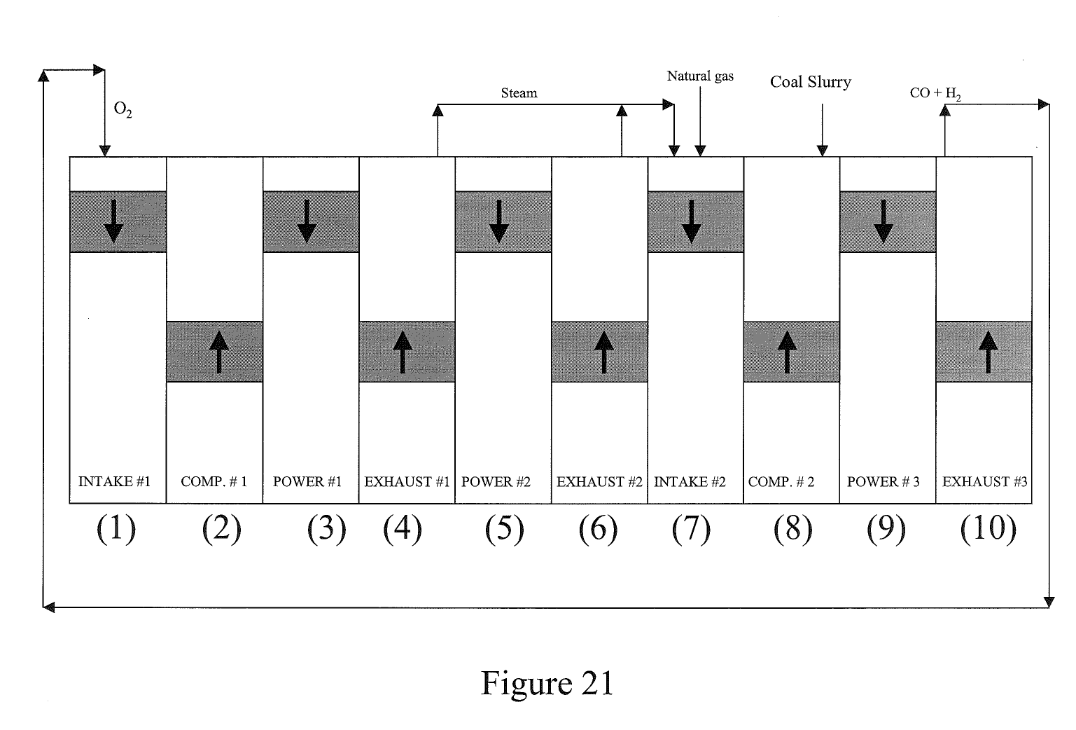

In yet another embodiment depicted in the FIG. 21, the reciprocating water shift reactor is used to convert carbonaceous feedstocks into syngas comprising carbon monoxide and hydrogen. When this syngas is fed into a gas to liquid (GTL) conversion facility (see the FIG. 1 for reference), synthetic hydrocarbon chains are produced. In order to provide the needed energy for this reaction an exothermic heat release that accompanies the conversion of carbon monoxide to carbon dioxide or hydrogen to water is used. An interesting option for this system is a possible ‘hydrogen-loop’ within the water gas shift reactor-gas to liquid facility combined system.

When natural gas or coal are used as the feed into the water gas shift reactor, the syngas is produced by combining C+H₂O═CO+H₂. This syngas is feed into the gas to, liquid section to produce hydrocarbon chains, thus producing a water molecule for each carbon monoxide molecule that enters the gas to liquid system. This system now has the ability to re-feed the water produced from the gas to liquid section back into the water gas shift reactor for syngas production. This option enables one to ensure a system or facility that has minimum water requirements, maximum hydrogen production within the syngas and full or almost full carbon utilization. All gas to liquid systems have some carbon dioxide emissions. Even when enough hydrogen is present for a full hydrocarbon chain production with all carbon present, some carbon dioxide gets emitted in real world scenarios. Actual facilities top out at about 90% carbon to hydrocarbon utilization. A bioreactor or synthesizing reactor could capture this small percent of carbon emitted and form other forms of carbon from it such as biomass. If it were a bioreactor, water would be required for this purpose as well. Bioreactors work through a process characterized by the equation CO₂+H₂O═CH₂O+O₂; or CO₂+H₂O ═CH₂Oₙ+O₍₃₋ₙ₎.

The FIG. 21 depicts a cylinder that functions on about 4 to about 12 or more strokes to facilitate a hydrogen engine combined with a water gas shift reactor. In one embodiment, the cylinder functions on about 4 to about 8 or more strokes. The water gas shift reactor can be used for reformation as well.

In one embodiment, the cylinder can function on 2, 4, 6 or more strokes performing as an internal combustion engine while producing steam for reformation or water gas shift reaction and utilizing waste heat within the combustion chamber for aiding the reformation or gas shift of feed stocks. This design combines the function of an internal combustion followed by reformation or water shift reaction in a repeating series.

The combustion chamber uses 2, 4, 6 or more strokes (sequence A) followed by the water shift reaction or reformation of 2, 4, 6 or more strokes (sequence B), to fulfill the reformation or gas shift. Once the gas shift is completed, the final exhaust stroke may follow to expel the oxidized carbon and hydrogen. This can be repeated over and over again.

With reference to the FIG. 21, stroke #1 which constitutes the intake stroke of a hydrogen engine (intake stroke #1) draws in oxygen. The stroke #1 of the cylinder represent the beginning stroke of sequence A, which represents the steps of a hydrogen engine. Oxygen (or air) is drawn in stroke #1 along with optional hydrogen and optional water for cooling. The oxygen may be obtained from air, a cryogenic separation system, a membrane separation system or a bioreactor. Hydrogen can be drawn into the cylinder along with oxygen during stroke #1 or can be injected at the end of stroke #2 to form water. At least some water can be produced by the reaction of hydrogen with water during stroke #1.

Stroke #2 is a compression stroke (comp. #1) where the gases in the cylinder are compressed. Hydrogen and oxygen drawn into the cylinder in stroke #1 may additionally react to produce water during stroke #2. Water formed during this stroke undergoes its first compression stroke.

Stroke #3 (power #1) is an expansion step that produces cranking force and steam. Water may be injected in during this step to control the gas/cylinder temperature and to control flame front speed. It heats up the chamber for the second power stroke (stroke #5) and supplies latent heat for reformation or water shift reaction strokes. Steam produced during this step may be used for the water gas shift reaction or reformation. In one embodiment, natural gas can be injected into the cylinder during stroke #1 or stroke #3 to undergo reformation. In another embodiment, carbon monoxide can be injected into the cylinder during stroke #1 or stroke #3 to undergo a water gas shift reaction to form carbon dioxide.

Stroke #4 (exhaust #1) is an exhaust stroke of Sequence A, but can be utilized as the source of water during the intake stroke of sequence B.

In one embodiment, water formed by the reaction of hydrogen with oxygen in strokes #2, #3 and/or #4 is not exhausted during stroke #4, but undergoes compression during stroke #4. Water is again injected at the beginning of stroke #5 (power #2) to form steam and a power stroke. Steam from stroke #'s 1 through 6 are optionally exhausted from the cylinder.

In one embodiment, the water from stroke #'s 1 through 6 is exhausted to a condenser, where nitrogen present may be removed. In another embodiment, the water (without the nitrogen) may be fed back to the cylinder for stroke #7 (intake #2). In yet another embodiment, the water may be retained in the cylinder for stroke #7 without leaving the cylinder. The water may be in the form of steam at the end of stroke #6.

The stroke #7 may function as the beginning of sequence B. In stroke #7, natural gas is injected into the cylinder or drawn in and undergoes reformation. In one embodiment, carbon monoxide can be drawn in or injected into the cylinder to undergo a water shift reaction. In yet another embodiment, coal slurry or combustible hydrocarbons (e.g., gasoline, diesel, petroleum, alcohols, or the like) can be introduced into the cylinder during stroke #7.

Stroke #8 (comp. #2) involves the raising the temperature or pressure to form the water shift reaction. This stroke may use latent heat from the preceding strokes. Stroke #9 (power #3) includes the expansion of gases undergoing reformation and/or water shift reaction. Stroke #10 (exhaust #3) involves exhaustion of the gases containing hydrogen and oxidized carbon.

Some of the hydrogen formed in the stroke #10 can be recycled to the cylinder for stroke #1.

In one embodiment, the cylinder of the FIG. 21 may operate in combination with a gasifier, algae bioreactor, and a gas to liquid system. In another embodiment, the cylinder of FIG. 21 may operate independently of the gasifier, algae bioreactor, and a gas to liquid system.

While the invention has been described in detail in connection with a number of embodiments, the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A system comprising:
a reciprocating water gas shift reactor; the water gas shift reactor being operative at speeds down to about 1 revolution per minute, while converting carbon monoxide (CO) and steam (H₂O) into carbon dioxide (CO₂) and hydrogen (H₂).

2. The system of claim 1, wherein the reciprocating water gas shift reactor is operative to convert natural gas or methane (CH₄) and steam (H₂O), into carbon dioxide (CO₂) and hydrogen (4H₂).

3. The system of claim 1, wherein the reciprocating water gas shift reactor is operative to convert synthesis gas (CO+H₂) and steam (H₂O), into carbon dioxide (CO₂) and hydrogen (2H₂).

4. The system of claim 1, wherein the reciprocating water gas shift reactor is operative to convert synthesis gas (CO+H₂) and steam (H₂O), into liquid fuel hydrocarbon (HC) plus alcohols and acids.

5. The system of claim 1, wherein the reciprocating water gas shift reactor is operative to function without being supplied with pressurized gas, or pressurized water.

6. The system of claim 1, wherein the reciprocating water gas shift reactor is operative to function without being supplied with heated gas or heated water.

7. The system of claim 1, wherein the reciprocating water gas shift reactor is a four stroke cycle unit.

8. The system of claim 1, wherein the reciprocating water gas shift reactor is a six stroke cycle unit.

9. The system of claim 1, wherein the reciprocating water gas shift reactor is a integral 8 stroke cycle unit.

10. The system of claim 1, wherein the reciprocating water gas shift reactor is a 4 stroke split cycle unit.

11. The system of claim 1, wherein the reciprocating water gas shift reactor is a 6 stroke split cycle unit.

12. A system comprising:
a hydrogen engine, or fuel cell with electric motor, and a water gas shift reactor; the hydrogen engine, or fuel cell with electric motor being in operative to drive the water gas shift reactor at speeds down to about 1 revolution per minute; and operative to convert carbon monoxide (CO) and steam (H₂O), into carbon dioxide (CO₂) and hydrogen (H₂).

13. The system of claim 12, wherein the hydrogen engine, and water shift reactor operate on a 4 stroke cycle.

14. The system of claim 12, wherein the hydrogen engine, and water shift reactor operate on a 6 stroke cycle.

15. The system of claim 12, wherein the hydrogen engine and water shift reactor operate on a 4 stroke split cycle.

16. The system of claim 12, wherein the hydrogen engine and water shift reactor operate on a 6 stroke split cycle.

17. A system comprising:
a reciprocating internal combustion engine; the internal combustion engine being operative to boil fluids with combustion exhaust gases to provide additional engine power output.

18. The system of claim 17, wherein the internal combustion engine is a 4 stroke cycle unit

19. The system of claim 17, wherein the internal combustion engine is a 6 stroke cycle unit

20. The system of claim 17, wherein the internal combustion engine is a integral 8 stroke cycle unit.

21. The system of claim 17, wherein the internal combustion engine is a 4 stroke split cycle unit

22. The system of claim 17, wherein the internal combustion engine is a 6 stroke split cycle unit

23. A system comprising:
a reciprocating water gas shift reactor; the reciprocating water gas shift reactor being operative to boil fluids with combustion exhaust gases to provide self driving power.

24. The system of claim 22, wherein the reciprocating water gas shift reactor is a 4 stroke cycle unit.

25. The system of claim 22, wherein the reciprocating water gas shift reactor is a six stroke cycle unit.

26. The system of claim 22, wherein the reciprocating water gas shift reactor is a integral 8 stroke cycle unit.

27. The system of claim 22, wherein the reciprocating water gas shift reactor is a 4 stroke split cycle unit.

28. The system of claim 22, wherein the reciprocating water gas shift reactor is a 6 stroke split cycle unit.

29. A system comprising:
a split cycle reciprocating internal combustion engine, and water gas shift reactor; the internal combustion engine, and water gas shift reactor, being operative to function with alternating power, and water gas shift reaction, from the same cylinders.

30. The system of claim 29, wherein the split cycle reciprocating internal combustion engine and water gas shift reactor is a 4 stroke split cycle reciprocating internal combustion engine.

31. The system of claim 29, wherein the split cycle reciprocating internal combustion engine and water gas shift reactor is a 6 stroke split cycle reciprocating internal combustion engine and is operative to function with additional steam power output.

32. A method comprising:
displacing a reciprocating piston to draw carbon monoxide into a cylinder;
compressing the carbon monoxide;
injecting steam and/or water into the cylinder;
mixing the carbon dioxide and stream to have fluid communication with a catalyst in the cylinder;
converting the carbon monoxide and steam into carbon dioxide; and hydrogen;
discharging carbon dioxide and hydrogen from the cylinder.

33. The method of claim 32, wherein natural gas or methane is drawn into the cylinder to discharge carbon dioxide and hydrogen.

34. The method of claim 32, wherein synthesis gas is drawn into the cylinder to discharge carbon dioxide and hydrogen.

35. The method of claim 32, wherein synthesis gas is drawn into the cylinder to discharge into liquid fuel hydrocarbon (HC) plus alcohols and acids.

36. A system comprising:
a reciprocating water gas shift reactor; the reciprocating water gas shift reactor being operative to function with a synthesis gas to liquid fuel plant; and
the inputs and outputs of the reciprocating water gas shift reactor, being operative to synergistically match those of the syngas to liquid fuel plant.
